(19) United States
(12) Patent Application Publication
(10) Pub. No.: US 2023/0409049 A1
(43) Pub. Date: Dec. 21, 2023

(54) AIRCRAFT FLIGHT CONTROL SYSTEMS THAT ACT SYMMETRICALLY TO CREATE AERODYNAMIC DRAG

(71) Applicant: ZSM HOLDINGS LLC, Dover, DE (US)

(72) Inventors: Mathew James ISLER, Sammamish, WA (US); Etan D. KARNI, Boulder, CO (US); Ashish GHIMIRE, Wichita, KS (US); Scott David REWERTS, Summerfield, NC (US)

(21) Appl. No.: 18/035,424

(22) PCT Filed: Nov. 16, 2021
(86) PCT No.: PCT/US2021/059540

§ 371 Date: May 4, 2023

Related U.S. Application Data
(60) Provisional application No. 63/114,240, filed on Nov. 16, 2020.

(51) Int. Cl. G05D 1/08; B64C 13/00

(52) U.S. Cl. CPC G05D 1/0816; B64C 13/00

(57) ABSTRACT

During landing and rejected-takeoff flight phases, aircraft drag is a useful force to supplement braking and reduce stopping distance. During descents, aircraft drag is a useful force in steepening flight path angle and achieving higher rates of vertical descent speed at a trimmed forward flight speed in unaccelerated flight. A flight control system is detailed herein that deflects opposing flight control components in a symmetric fashion to increase aircraft drag, while maintaining controllability.

### CROSS-REFERENCE TO RELATED APPLICATIONS

This application claims priority to and the benefit of U.S. Provisional Application Ser. No. 63/114,240, entitled “AIRCRAFT FLIGHT CONTROL SYSTEMS THAT ACT SYMMETRICALLY TO CREATE AERODYNAMIC DRAG,” and filed Nov. 16, 2020, the contents of which is incorporated by reference herein in its entirety.

### FIELD

The present disclosure relates to control surface and control system designs for cargo aircraft, and more particularly to systems and methods for deflecting opposing flight control components in a symmetric fashion to increase aircraft drag while maintaining controllability.

### BACKGROUND

Renewable energy remains an increasingly important resource year-over-year. While there are many forms of renewable energy, wind energy has increased an average of about 19 percent annually since 2007. The increase in global demand in recent years for more wind energy has catalyzed drastic advances in wind turbine technology, including the development of larger, better-performing wind turbines. Better-performing wind turbines can at least sometimes mean larger turbines, as generally turbines with larger rotor diameters can capture more wind energy. As turbines continue to improve in performance and efficiency, more and more wind farm sites in previously undeveloped locations become viable both onshore and offshore. These sites may also be existing sites, where older turbines need replacement by better-performing, more efficient turbines, and new sites.

A limiting factor to allow for the revitalization of old sites and development of new sites is transporting the wind turbines, and related equipment, to the sites. Wind turbine blades are difficult to transport long distances due to the terrestrial limitations of existing air vehicles and roadway infrastructures. Onshore transportation has traditionally required truck or rail transportation on existing infrastructure. Both roads and railways are limited by height and width of tunnels and bridges. Road transport has additional complications of lane width, road curvature, and the need to pass through urban areas that may require additional permitting and logistics, among other complications. Offshore transportation by ship is equally, if not more so, limiting. For example, delivery of parts can be limited to how accessible the offshore location is by ship due to various barriers (e.g., sand bars, coral reefs) and the like in the water and surrounding areas, as well as the availability of ships capable of handling such large structures.

Whether onshore or offshore, the road vehicle or ship options for transporting such equipment has become more limited, particularly as the size of wind turbines increase. Delivery is thus limited by the availability of vehicles and ships capable of handling such large structures. The very long lengths of wind turbine blades (some are presently 90 meters long, 100 meters long, or even longer) make conventional transportation by train, truck, or ship very difficult and complicated. Unfortunately, the solution is not as simple as making transportation vehicles longer and/or larger. There are a variety of complications that present themselves as vehicles are made longer and/or larger, including but not limited to complications of: load balancing of the vehicle; load balancing the equipment being transported; load balancing the two with respect to each other; handling, maneuverability, and control of the vehicle; and other complications that would be apparent to those skilled in the art.

Further, whether onshore or offshore, delivery of parts can be slow and severely limited by the accessibility of the site. Whether the site being developed is old or new, the sites can often be remote, and thus not near suitable transportation infrastructure. The sites may be far away from suitable roads and rails (or other means by which cargo may be transported) to allow for easy delivery of cargo for use in building the turbines at the site and/or other equipment used in developing the site. New sites are often in areas without any existing transportation infrastructure at all, thus requiring new construction and special equipment. Ultimately, transportation logistics become cost prohibitive, resulting in a literal and figurative roadblock to further advancing the use of wind energy on a global scale.

Existing cargo aircraft, including the largest aircraft ever to fly, are not able to transport extremely largo cargo to locations serviced by short runways. This limitation is often the result of cargo aircraft having a high minimum landing speed, as well as a limited ability to generate speedbraking to assist in slowing the aircraft down. Both of these constraint have many causes, but large cargo aircraft are traditionally not designed to minimize landing runway length. This is at least because designing such an aircraft may compromise other performance characteristics without meaningfully expanding the serviceable airfields due to other constraints, such as the maximum weight serviceable by the runway.

Accordingly, at least for extremely large cargo aircraft with relatively light maximum weights there is a need for control surface arrangements and control systems that shorten the minimum landing runway length without negatively impacting aircraft performance Such arrangements and control systems may also be beneficial for other aircrafts as well.

### SUMMARY

Certain examples of the present disclosure include control systems and methods for operating control surfaces of a cargo aircraft to facilitate short runway landings. Examples of the present disclosure include extremely large cargo aircraft capable of both carrying extremely long payloads and being able to take off and land at runways that are significantly shorter than those required by most, if not all, existing large aircraft. For purposes of the present disclosure, a large or long aircraft is considered an aircraft having a fuselage length from fuselage nose tip to fuselage tail tip that is at least approximately 60 meters long. The American Federal Aviation Administration (FAA) defines a large aircraft as any aircraft of more than 12,500 pounds maximum certificated takeoff weight, which can also be considered a large aircraft in the present context, but the focus of size is generally related to a length of the aircraft herein. One example of such an oversized payload capable of being transported using examples of this present disclosure are wind turbine blades, the largest of which can be over 100 meters in length. Examples of the present disclosure enable a payload of such an extreme length to be transported within the cargo bay of an aircraft having a fuselage length only slighter longer than the payload. Such an aircraft can also take off and land at most existing commercial airports, as well as runways that are even shorter, for instance because they are built at a desired location for landing such cargo aircraft near a site where the cargo is to be used, such as a landing strip built near or as part of a wind farm.

An example of the present disclosure is a method of operating an aircraft in flight, the method including deflecting a first empennage control surface to cause a first drag force and at least one of a first yawing moment or a first pitching moment on the aircraft and deflecting a second empennage control surface to cause a second drag force and at least one of a second yawing moment or a second pitching moment on the aircraft. The method further includes at least one of: (i) the first and second yawing moments destructively combining to generate a resultant yawing moment about a center of gravity of the aircraft that is less than one or both of the first and second yawing moments; or (ii) the first and second pitching moments destructively combining to generate a resulting pitching moment about a center of gravity of the aircraft that is less than one or both of the first and second pitching moments. Still further, the first and second drag forces constructively combine to generate a resultant drag force on the aircraft.

In at least some embodiments, at least one of the first and second yawing moments can cancel to generate no net yaw moment on the aircraft or the first and second pitching moments cancel to generate no net pitching moment on the aircraft. In some examples, the first empennage control surface can be moved to a first deflection angle, the second empennage control surface can be moved to a second deflection angle, and the first and second deflection angles can be equal and opposite. The moving of the first and second empennage control surfaces can take place during a landing operation of the aircraft such that the resultant drag force can at least partially reduce a groundspeed of the aircraft to a touchdown speed while the aircraft is still in the air. The moving of the first and second empennage control surfaces can take place during the landing operation of the aircraft and after a touchdown operation such that the resultant drag force can at least partially reduce a groundspeed of the aircraft to at least one of a taxi speed or a stop. The deflecting of the first and second empennage control surfaces can take place during at least one of: a rejected takeoff operation, an increased descent rate operation, or an unintended acceleration of the aircraft such that the resultant drag force at least partially reduces a groundspeed or airspeed of the aircraft.

The first and second empennage control surfaces can be disposed approximately symmetrically about a longitudinal axis of the aircraft. In some examples, the first empennage control surface includes at least one right rudder and the second empennage control surface includes at least one left rudder. The right rudder(s) can include an upper right rudder and a lower right rudder, and the left rudder(s) can include an upper left rudder and a lower left rudder. In some such examples, the upper and lower right rudders and the upper and lower left rudders form an H-configuration for an empennage of the aircraft. In some examples, the first empennage control surface includes a first elevator and the second empennage control surface includes a second elevator.

The method can further include reducing an airspeed of the aircraft while conducting at least one of a yawing movement or a pitching movement by simultaneously controlling the respective resultant yawing moment or pitching movement and resultant drag force. The simultaneously controlling can include adjusting both of the first and second empennage control surfaces. In some such examples, reducing an airspeed of the aircraft while conducting at least one of a yawing movement or a pitching movement can take place during a landing operation of the aircraft.

The method can further include deflecting a first aileron to cause a first additional drag force and a first rolling moment on the aircraft and deflecting a second aileron to cause a second additional drag force and a second rolling moment on the aircraft. In some such instances, the first and second rolling moments can destructively combine to generate a resultant rolling moment about a center of gravity of the aircraft that is less than one or both of the first and second rolling moments. Further, the first and second additional drag forces can constructively combine to generate a resultant drag force on the aircraft. The first and second rolling moments can cancel to generate no net rolling moment on the aircraft. In some such examples, the first aileron can be deflected a first degree, the second aileron can be deflected a second degree, and the first and second degrees can be equal and opposite.

Another example of the present disclosure is an aircraft control system with a flight control processor configured to simultaneously command (1) deflection of a first empennage control surface to cause a first drag force and at least one of a first yawing moment or a first pitching moment on an aircraft; and (2) deflection of a second empennage control surface to cause a second drag force and at least one of a second yawing moment or a second pitching moment on the aircraft. Further, at least one of: (a) the first and second yawing moments destructively combine to generate a resultant yawing moment about a center of gravity of the aircraft that is less than one or both of the first and second yawing moments; or (b) the first and second pitching moments destructively combine to generate a resulting pitching moment about a center of gravity of the aircraft that is less than one or both of the first and second pitching moments. Still further, the first and second drag forces constructively combine to generate a resultant drag force on the aircraft.

In some examples, the flight control processor can be further configured to command the deflections of the first and second empennage control surfaces such that the at least one of the first and second yawing moments cancel to generate no net yawing moment on the aircraft or the first and second pitching moments cancel to generate no net pitching moment on the aircraft.

The flight control processor can be further configured to command equal and opposite deflections of the first and second empennage control surfaces. The flight control processor can be further configured to assist the control of the aircraft during a landing operation, for instance by commanding the deflection such that the resultant drag force at least partially reduces a groundspeed of the aircraft to a touchdown speed. In some examples, the first empennage control surface includes at least one right rudder and the second empennage control surface includes at least one left rudder. The right rudder(s) can include an upper right rudder and a lower right rudder and the left rudder(s) can include an upper left rudder and a lower left rudder. In some such examples, the upper and lower right rudders and the upper and lower left rudders can form an H-configuration for an empennage of the aircraft.

The flight control processor can be further configured to reduce the airspeed of the aircraft while conducting at least one of a yawing movement or a pitching movement. This can be achieved, for example, by simultaneously controlling the respective resultant yawing moment or pitching moment and resultant drag force by adjusting the commanded deflections of the first and second empennage control surfaces.

The flight control processor can be further configured to simultaneously command (1) deflection of a first aileron to cause a first additional drag force and a first rolling moment on the aircraft; and (2) deflection of a second aileron to cause a second additional drag force and a second rolling moment on the aircraft. The first and second rolling moments can destructively combine to generate a resultant rolling moment about a center of gravity of the aircraft that is less than one or both of the first and second rolling moments. Further, the first and second additional drag forces can constructively combine to generate a resultant drag force on the aircraft. The flight control processor can be further configured to command the deflections of the first and second ailerons such that the first and second rolling moments cancel to generate no net rolling moment on the aircraft. In some such instances, the flight control processor can be further configured to command equal and opposite deflections of the first and second ailerons.

### BRIEF DESCRIPTION OF DRAWINGS

This disclosure will be more fully understood from the following detailed description taken in conjunction with the accompanying drawings, in which:

FIG. 1A is an isometric view of one exemplary embodiment of an aircraft;

FIG. 1B is a side view of the aircraft of FIG. 1A;

FIG. 2A is an isometric view of the aircraft of FIG. 1A with a nose cone door in an open position to provide access to an interior cargo bay of the aircraft;

FIG. 2B is an isometric view of the aircraft of FIG. 2A with a payload being disposed proximate to the aircraft for loading into the interior cargo bay;

FIG. 2C is an isometric, partial cross-sectional view of the aircraft of FIG. 2B with the payload being partially loaded into the interior cargo bay;

FIG. 2D is an isometric, partial cross-sectional view of the aircraft of FIG. 2C with the payload being fully loaded into the interior cargo bay;

FIG. 3 is a schematic side view of an aircraft in the prior art, illustrating a lateral axis of rotation with respect to tail strike;

FIG. 4A is a side view of an alternative exemplary embodiment of an aircraft;

FIG. 4B is a side transparent view of the aircraft of FIG. 4A;

FIG. 4C is a side view of the aircraft of FIG. 4B in a take-off position;

FIG. 5A is the side view of the aircraft of FIG. 1A with some additional details removed for clarity;

FIG. 5B is the side view of the aircraft of FIG. 1A showing the vertical extension of the aft fuselage above the forward portion of the fuselage;

FIG. 6A is a side cross-sectional view of the aircraft of FIG. 5A, including an interior cargo bay of the aircraft;

FIG. 6B is the side cross-sectional view of the aircraft of FIG. 6A with an exemplary payload disposed in the interior cargo bay;

FIG. 6C is the side cross-sectional view of the aircraft of FIG. 6A with a schematic of an exemplary maximum-length payload disposed in the interior cargo bay;

FIG. 6D is the side cross-sectional view of the aircraft of FIG. 6A with a schematic of an exemplary maximum-weight payload disposed in the interior cargo bay of the aircraft;

FIG. 7 is an isometric view of the aircraft of FIG. 6A illustrating a lower support system that extends along the interior cargo bay from a forward entrance to an aft section of the interior cargo bay in an aft portion of a fuselage of the aircraft;

FIG. 8A is an isometric view of the aircraft of FIG. 1A showing resultant control surface forces about the center of gravity and a detail view of the empennage showing control surface movement;

FIG. 8B is an isometric view of the aircraft of FIG. 8A showing no control surface forces about the center of gravity and a detail view of the empennage showing symmetric control surface movement to induce drag without rotation of the aircraft about the center of gravity;

FIG. 8C is an isometric view of the aircraft of FIG. 8A showing increasing control surface forces about the center of gravity and a detail view of the empennage showing symmetric control surface movement to generate drag while controlling rotation of the aircraft about the center of gravity;

FIG. 9 is a schematic of a control system configured to increase drag using symmetric rudder commands;

FIG. 10A is a side view of another example of an empennage control surface arrangement;

FIG. 10B is a side view of yet another examples of an empennage control surface arrangement; and

FIG. 11 is a block diagram of one exemplary embodiment of a computer system for use in conjunction with the present disclosures.

### DETAILED DESCRIPTION

Certain exemplary embodiments will now be described to provide an overall understanding of the principles of the structure, function, manufacture, and use of the devices, systems, aircraft, and methods disclosed herein. One or more examples of these embodiments are illustrated in the accompanying drawings. Those skilled in the art will understand that the devices, systems, aircraft, components related to or otherwise part of such devices, systems, and aircraft, and methods specifically described herein and illustrated in the accompanying drawings are non-limiting embodiments and that the scope of the present disclosure is defined solely by the claims. The features illustrated or described in connection with one embodiment may be combined with the features of other embodiments. Such modifications and variations are intended to be included within the scope of the present disclosure. Some of the embodiments provided for herein may be schematic drawings, including possibly some that are not labeled as such but will be understood by a person skilled in the art to be schematic in nature. They may not be to scale or may be somewhat crude renderings of the disclosed components. A person skilled in the art will understand how to implement these teachings and incorporate them into work systems, methods, aircraft, and components related to each of the same, provided for herein.

To the extent the present disclosure includes various terms for components and/or processes of the disclosed devices, systems, aircraft, methods, and the like, one skilled in the art, in view of the claims, present disclosure, and knowledge of the skilled person, will understand such terms are merely examples of such components and/or processes, and other components, designs, processes, and/or actions are possible. By way of non-limiting example, while the present application describes operating port and starboard control surfaces, such as a rudders, alternatively, or additionally, operation of other control surfaces is possible, such as elevators, ailerons, and/or spoilers. In the present disclosure, like-numbered and like-lettered components of various embodiments generally have similar features when those components are of a similar nature and/or serve a similar purpose. To the extent terms such as front, back, top, bottom, forward, aft, proximal, distal, etc. are used to describe a location of various components of the various disclosures, such usage is by no means limiting, and is often used for convenience when describing various possible configurations. The foregoing notwithstanding, a person skilled in the art will recognize the common vernacular used with respect to aircraft, such as the terms “forward” and “aft,” and will give terms of those nature their commonly understood meaning. Further in some instances, terms like forward and proximal or aft and distal may be used in a similar fashion.

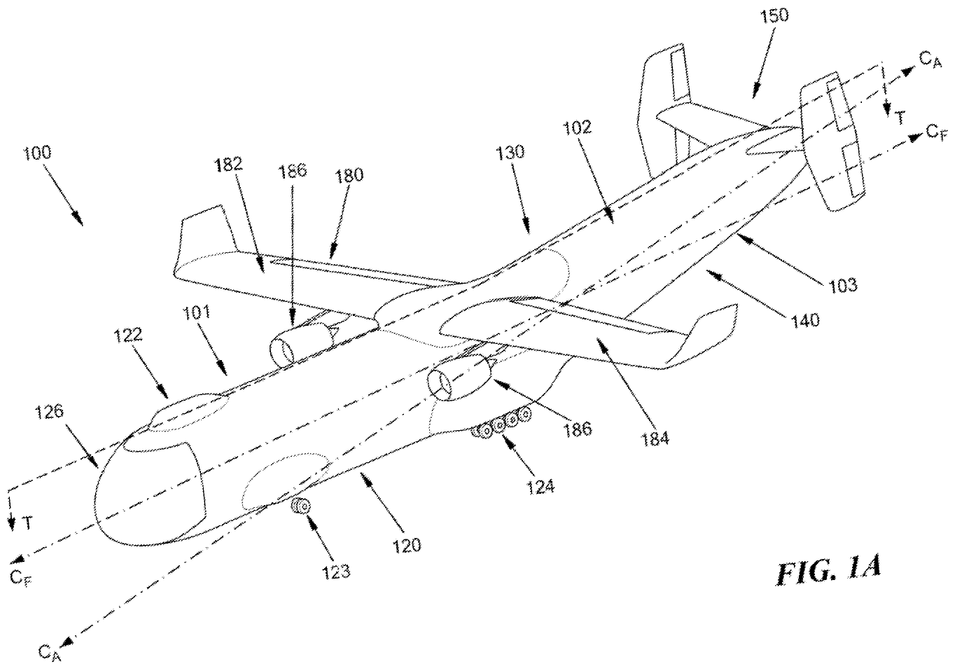

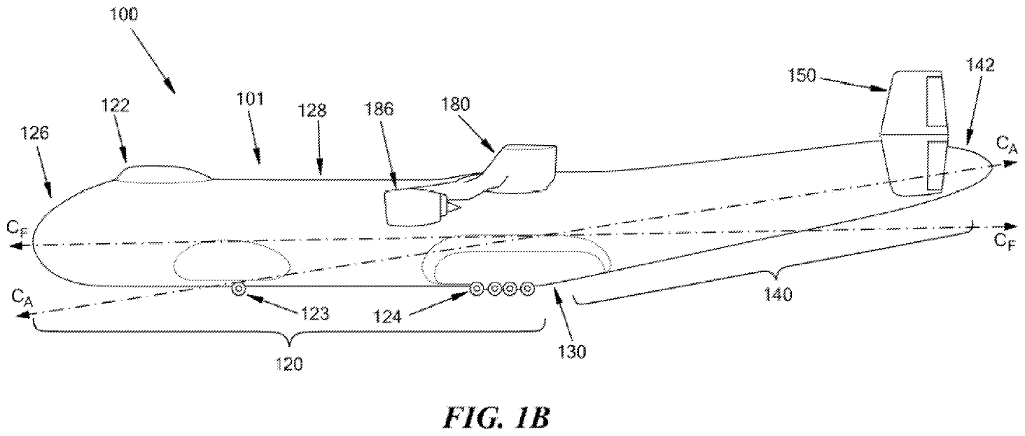

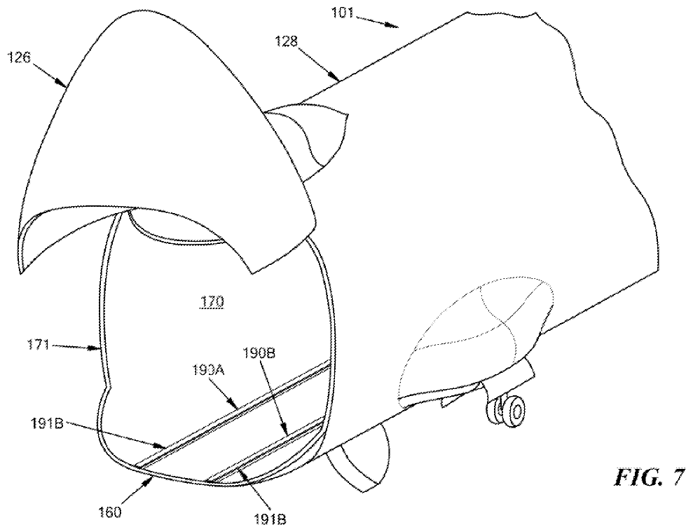

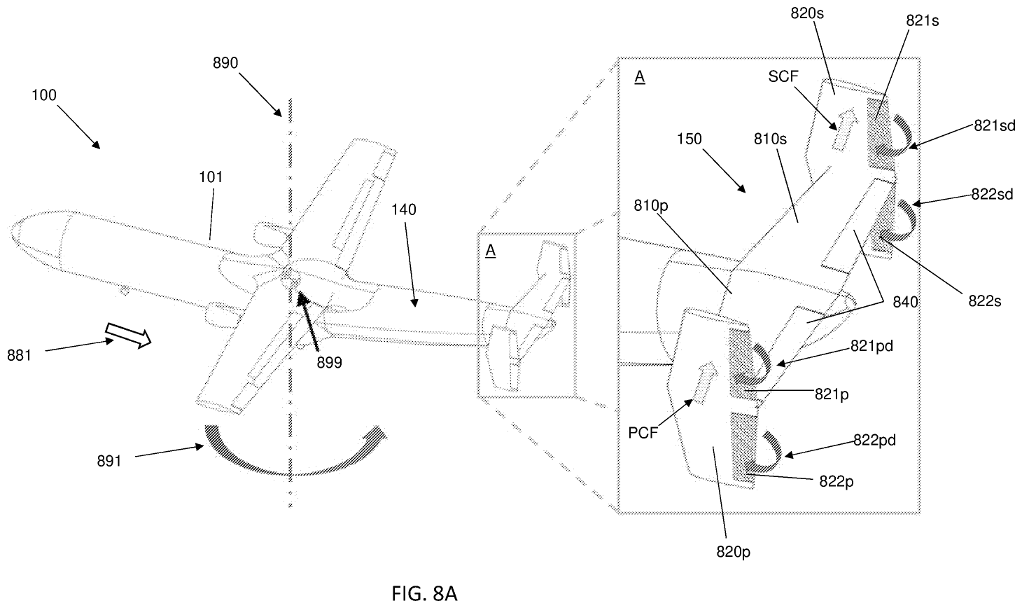

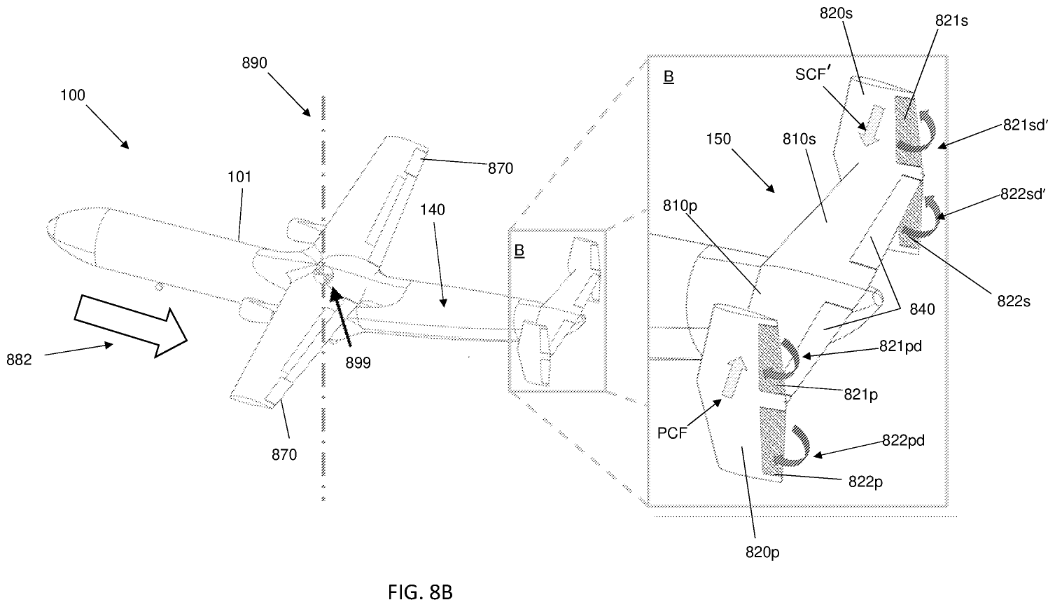

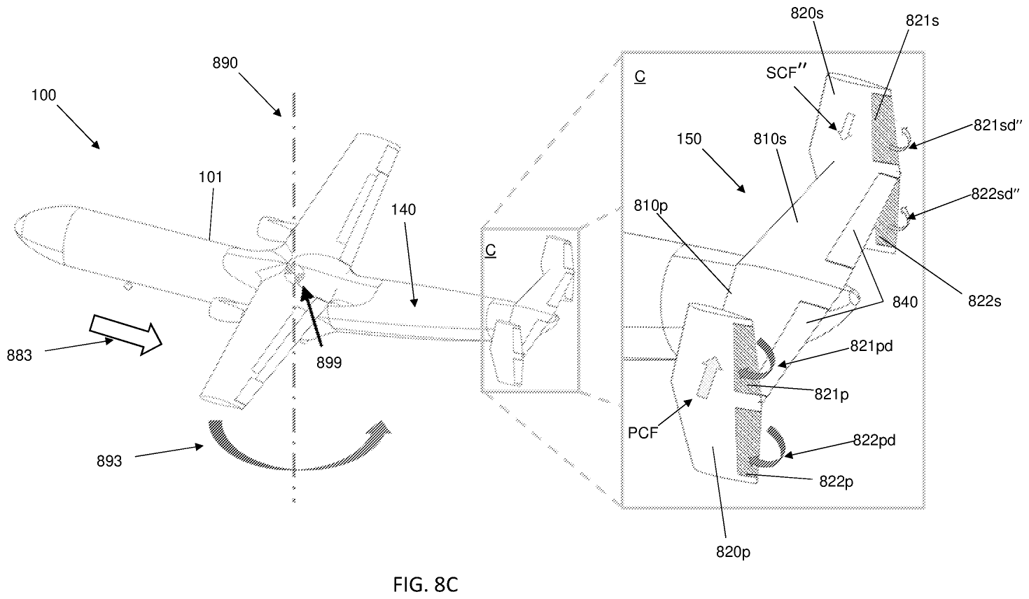

Fixed-wing aircraft traditionally receive the vast majority of their lifting force from a primary wing that passes through the body of the fuselage to deliver the lifting force to the rest of the aircraft. However, the ability to pitch and yaw the aircraft is largely dependent on control surfaces mounted at the aft end of the aircraft to utilize the largest moment arm about the center of gravity of the aircraft. Almost all aircraft have some control surfaces disposed about the aft end, often referred to as a tail or empennage. These control surfaces can include both vertical and horizontal stabilizers, with each having a rotatable (or otherwise deflectable) surface that, when actuated, generates a force on the stabilizer to rotate the plate (e.g., pitch and yaw). Aspects of the present disclosure include empennage configurations systems and methods for actuating symmetric control surfaces in a way to generate a drag force from the empennage largely without any other forces acting about the center of gravity of the aircraft. In this manner, aspects of the present disclosure includes large cargo aircraft with empennage control surface arrangements, as well as a control system that includes using H-tail rudders as speedbrakes at least during landing and/or rejected takeoff maneuvers. One such large cargo aircraft with short takeoff and landing requirements is illustrated in FIGS. 1A and 7, with a detailed illustration of the empennage control surfaces and control systems in FIGS. 8A-11.

### Aircraft

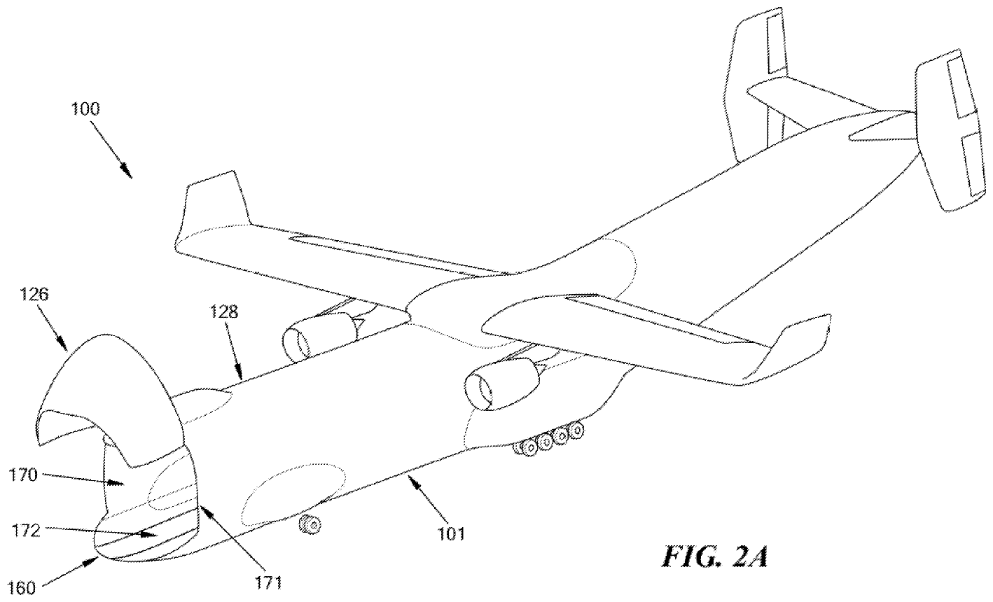

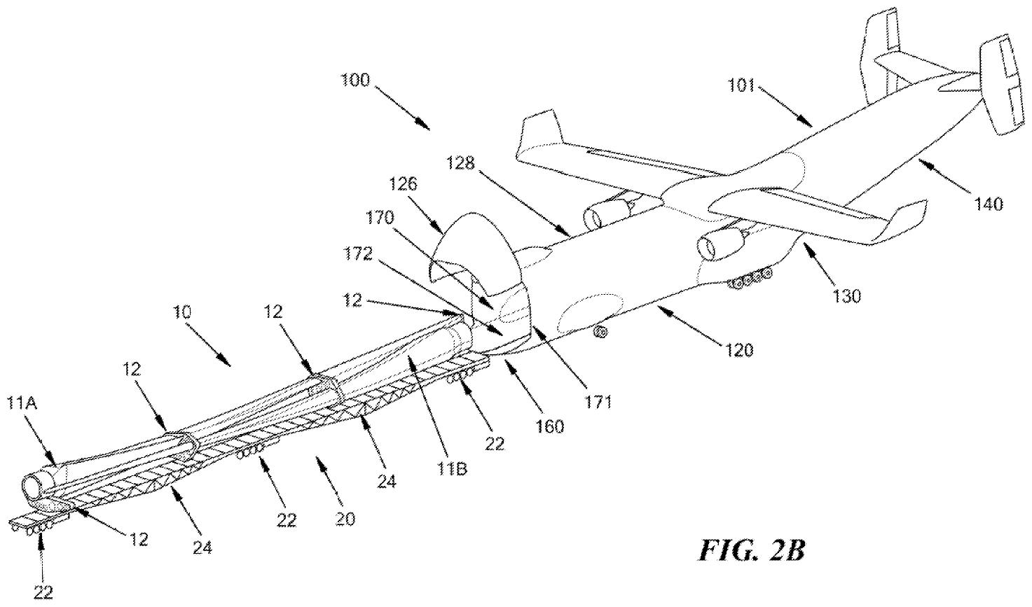

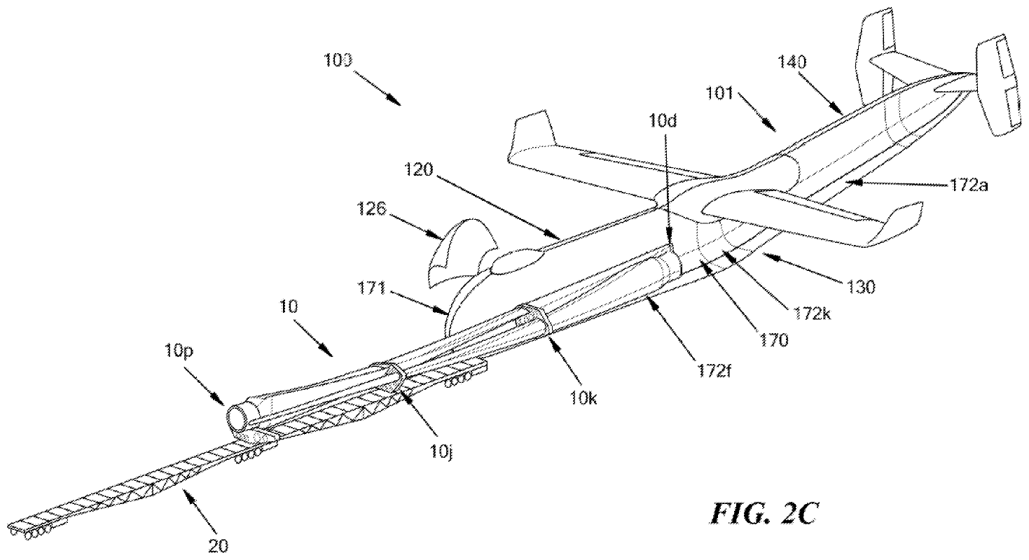

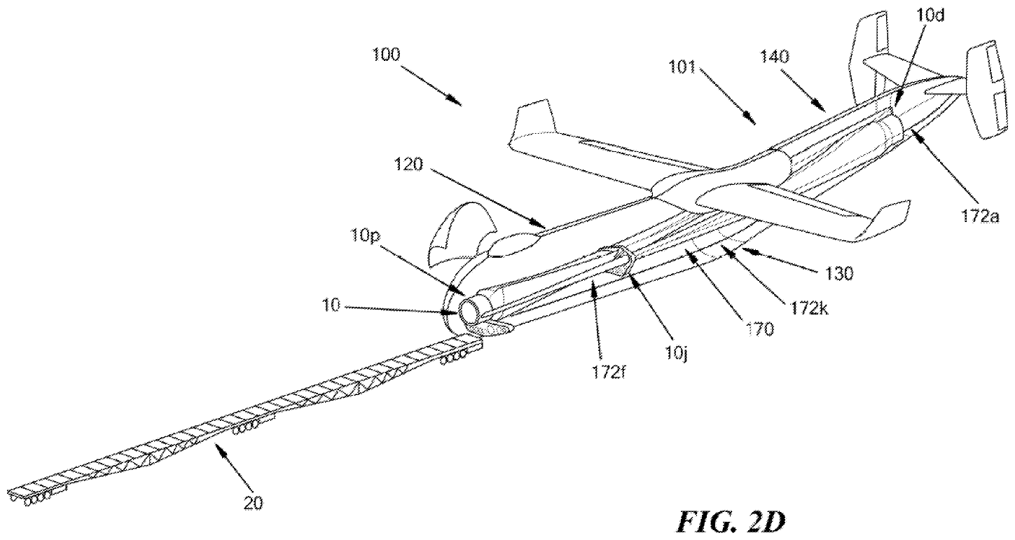

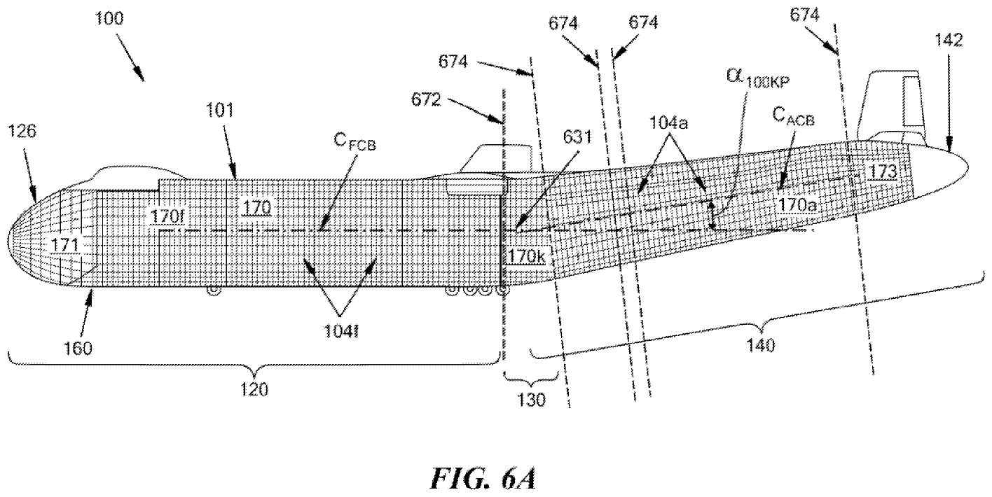

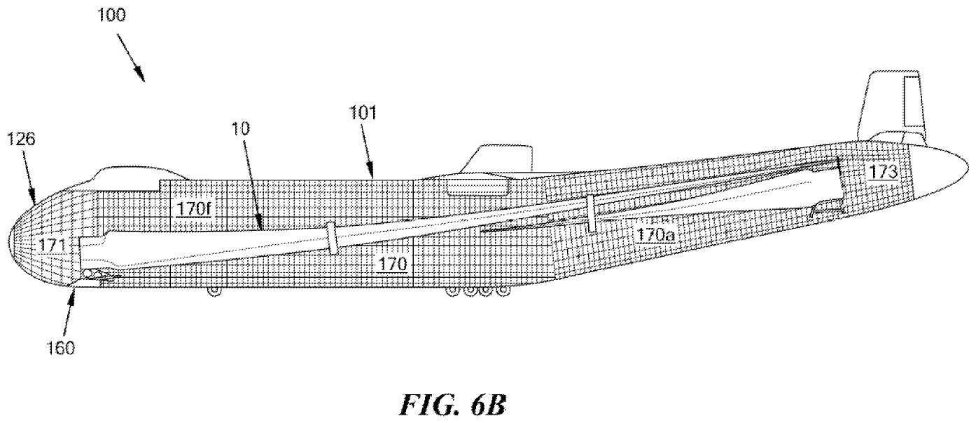

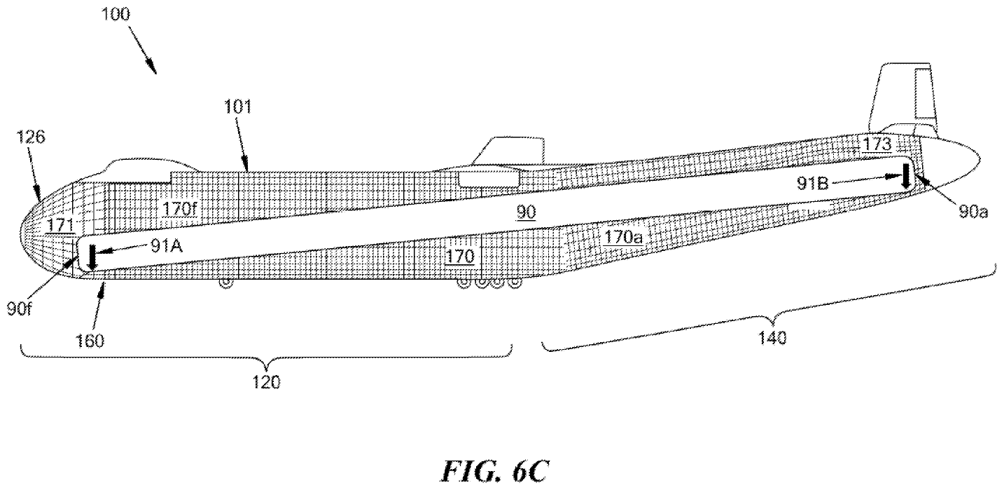

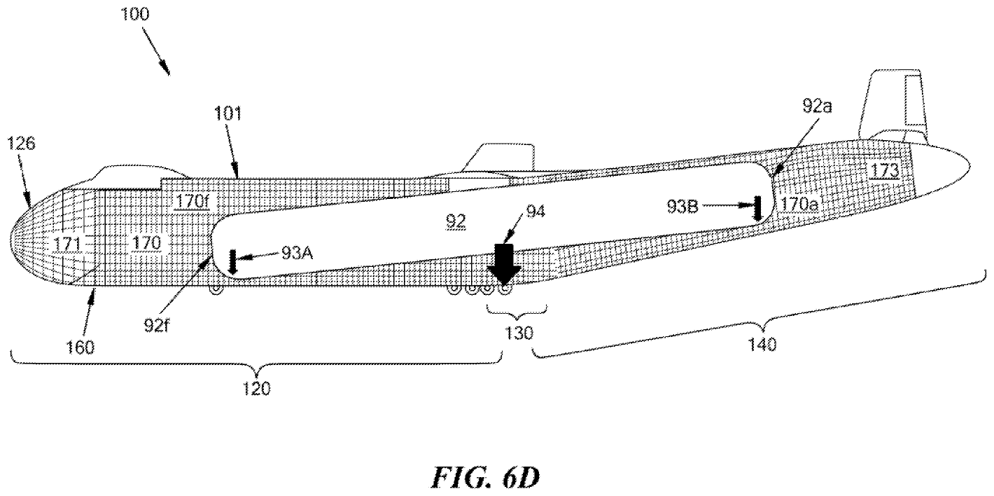

The focus of the present disclosures is described with respect to a large aircraft 100, such as an airplane, illustrated in FIGS. 1A and 1B, along with the loading of a large payload into the aircraft, illustrated at least in FIGS. 2A-2D, and 6B-6D. Additional details about the aircraft and payload may be described with respect to the other figures of the present disclosure as well. In the illustrated embodiment, a payload 10 is a combination of two wind turbine blades 11A and 11B (FIGS. 2B-2D), although a person skilled in the art will appreciate that other payloads are possible. Such payloads can include other numbers of wind turbine blades (e.g., one, three, four, five, etc., or segments of a single even larger blade), other components of wind turbines (e.g., tower segments, generator, nacelle, gear box, hub, power cables, etc.), or many other large structures and objects whether related to wind turbines or not. The present application can be used in conjunction with most any large payload—large for the present purposes being at least about 57 meters long, or at least about meters long, or at least about 65 meters long, or at least about 75 meters long, or at least about 85 meters long, or at least about 90 meters long, or at least about 100 meters long, or at least about 110 meters long, or at least about 120 meters long—or for smaller payloads if desired. Some non-limiting examples of large payloads that can be used in conjunction with the present disclosures beyond wind turbines include but are not limited to industrial oil equipment, mining equipment, rockets, military equipment and vehicles, commercial aerospace vehicles, crane segments, aircraft components, space launch rocket boosters, helicopters, generators, or hyperloop tubes. In other words, the aircraft 100 can be used with most any size and shape payload, but has particular utility when it comes to large, often heavy, payloads.

As shown, for example in FIGS. 1A-1B and 2A-2D, the aircraft 100, and thus its fuselage 101, includes a forward end 120 and an aft end 140, with a kinked portion 130 connecting the forward end 120 to the aft end 140. The forward end 120 is generally considered any portion of the aircraft 100, and related components, that are forward of the kinked portion 130 and the aft end 140 is considered any portion of the aircraft 100, and related components, that are aft of the kinked portion 130. The kinked portion 130, as described in greater detail below, is a section of the aircraft 130 in which both a top-most outer surface 102 and a bottom-most outer surface 103 of the fuselage 101 become angled (notably, the placement of reference numerals 102 and 103 in the figures do not illustrate location of the “kink” since they more generally refer to the top-most and bottom-most surfaces of the fuselage 101), as illustrated by an aft centerline C_{A} of the aft end 140 of the fuselage 101 with respect to a forward centerline C_{F} of the forward end 120 of the fuselage 101.

The forward end 120 can include a cockpit or flight deck 122, and landing gears, as shown a forward or nose landing gear 123 and a rear or main landing gear 124. The illustrated embodiment does not show various components used to couple the landing gears 123, 124 to the fuselage 101, or operate the landing gears (e.g., actuators, braces, shafts, pins, trunnions, pistons, cylinders, braking assemblies, etc.), but a person skilled in the art will appreciate how the landing gears 123, 124 are so connected and operable in conjunction with the aircraft 100. The forward-most end of the forward end 120 includes a nose cone 126. As illustrated more clearly in FIG. 2A, the nose cone 126 is functional as a door, optionally being referred to the nose cone door, thus allowing access to an interior cargo bay 170 defined by the fuselage 101 via a cargo opening 171 exposed by moving the nose cone door 126 into an open or loading position (the position illustrated in FIG. 2A; FIGS. 1A and 1B illustrate the nose cone door 126 in a closed or transport position). The door may operate by rotating vertically tip-upwards about a lateral axis, or by rotating horizontally tip-outboards about a vertical axis, or by other means as well such as translation forwards then in other directions, or by paired rotation and translation, or other means.

As described in greater detail below, the interior cargo bay 170 is continuous throughout the length of the aircraft 101, i.e., it spans a majority of the length of the fuselage. The continuous length of the interior cargo bay 170 includes the space defined by the fuselage 101 in the forward end 120, the aft end 140, and the kinked portion 130 disposed therebetween, such spaces being considered corresponding to the forward bay, aft bay, and kinked bay portions of the interior cargo bay 170. The interior cargo bay 170 can thus include the volume defined by nose cone 126 when it is closed, as well as the volume defined proximate to a fuselage tail cone 142 located at the aft end 140. In the illustrated embodiment of FIG. 2A, the nose cone door 126 is hinged at a top such that it swings clockwise towards the fuselage cockpit 122 and a fixed portion or main section 128 of the fuselage 101. In other embodiments, a nose cone door can swing in other manners, such as being hinged on a left or right side to swing clockwise or counter-clockwise towards the fixed portion 128 of the fuselage. The fixed portion 128 of the forwards fuselage 101 is the portion that is not the nose cone 126, and thus the forwards fuselage 101 is a combination of the fixed portion 128 and the nose cone 126. Alternatively, or additionally, the interior cargo bay 170 can be accessed through other means of access known to those skilled in the art, including but not limited to a hatch, door, and/or ramp located in the aft end 140 of the fuselage 101, hoisting cargo into the interior cargo bay 170 from below, and/or lowering cargo into the interior cargo bay 170 from above. One advantage provided by the illustrated configuration, at least as it relates to some aspects of loading large payloads, is that by not including an aft door, the interior cargo bay 170 can be continuous, making it significantly easier to stow cargo in the aft end 140 all the way into the fuselage tail cone 142. While loading through an aft door is possible with the present disclosures, doing so would make loading into and use of the interior cargo bay 170 space in the aft end 140 all the way into the fuselage tail cone 142 much more challenging and difficult to accomplish—a limitation faced in existing cargo aircraft configurations. Existing large cargo aircraft are typically unable to add cargo in this way (e.g., upwards and aftwards) because any kink present in their aft fuselage is specifically to create more vertical space for an aft door to allow large cargo into the forwards portion of the aircraft.

A floor 172 can be located in the interior cargo bay 170, and can also extend in a continuous manner, much like the bay 170 itself, from the forward end 120, through the kinked portion 130, and into the aft end 140. The floor 172 can thus be configured to have a forward end 172f, a kinked portion 172k, and an aft end 172a. In some embodiments, the floor 172 can be configured in a manner akin to most floors of cargo bays known in the art. In some other embodiments, discussed in greater detail below, one or more rails can be disposed in the interior cargo bay 170 and can be used to assist in loading a payload, such as the payload 10, into the interior cargo bay 170 and/or used to help secure the location of a payload once it is desirably positioned within the interior cargo bay 170.

Opening the nose cone 126 not only exposes the cargo opening 171 and the floor 172, but it also provides access from an outside environment to a cantilevered tongue 160 that extends from or otherwise defines a forward-most portion of the fixed portion 128 of the fuselage 101. The cantilevered tongue can be an extension of the floor 172, or it can be its own feature that extends from below or above the floor 172 and associated bottom portion of the fuselage 101. The cantilevered tongue 160 can be used to support a payload, thus allowing the payload to extend into the volume of the interior cargo bay 170 defined by the nose cone 126.

A wingspan 180 can extend substantially laterally in both directions from the fuselage. The wingspan 180 includes both a first fixed wing 182 and a second fixed wing 184, the wings 182, 184 extending substantially perpendicular to the fuselage 101 in respective first and second directions which are approximately symmetric about a longitudinal-vertical plane away from the fuselage 101, and more particularly extending substantially perpendicular to the centerline C_{F}. Wings 182, 184 being indicated as extending from the fuselage 101 do not necessarily extend directly away from the fuselage 101, i.e., they do not have to be in direct contact with the fuselage 101. Further, the opposite directions the wings 182, 184 extend from each other can alternatively be described as the second wing 184 extending approximately symmetrically away from the first wing 182. As shown, the wings 182, 184 define approximately no sweep angle and no dihedral angle. In alternative embodiments, a sweep angle can be included in the tip-forwards (−) or tip-aftwards (+) direction, the angle being approximately in the range of about −40 degrees to about +60 degrees. In other alternative embodiments, a dihedral angle can be included in the tip-downwards (negative, or “anhedral”) or tip-upwards (positive, or “dihedral”) direction, the angle being approximately in the range of about −5 degrees to about +5 degrees. Other typical components of wings, including but not limited to slats for increasing lift, flaps for increasing lift and drag, ailerons for changing roll, spoilers for changing lift, drag, and roll, and winglets for decreasing drag can be provided, some of which a person skilled in the art will recognize are illustrated in the illustrations of the aircraft 100 (other parts of wings, or the aircraft 100 more generally, not specifically mentioned in this detailed description are also illustrated and recognizable by those skilled in the art). Engines, engine nacelles, and engine pylons 186 can also be provided. In the illustrated embodiment, two engines 186, one mounted to each wing 182, 184 are provided. Additional engines can be provided, such as four or six, and other locations for engines are possible, such as being mounted to the fuselage 101 rather than the wings 182, 184.

The kinked portion 130 provides for an upward transition between the forward end 120 and the aft end 140. The kinked portion 130 includes a kink, i.e., a bend, in the fixed portion 128 of the fuselage 101 such that both the top-most outer surface 102 and the bottom-most outer surface 103 of the fuselage 101 become angled with respect to the centerline C_{F} of the forward end 120 of the aircraft 100, i.e., both surfaces 102, 103 include the upward transition provided for by the kinked portion 130. As shown at least in FIG. 1B, the aft-most end of the aft end 140 can raise entirely above the centerline C_{F}. In the illustrated embodiment, the angle defined by the bottom-most outer surface 103 and the centerline C_{F} is larger than an angle defined by the top-most outer surface 102 and the centerline C_{F}, although other configurations may be possible. Notably, although the present disclosure generally describes the portions associated with the aft end 140 as being “aft,” in some instances they may be referred to as part of a “kinked portion” or the like because the entirety of the aft end 140 is angled as a result of the kinked portion 130. Thus, references herein, including in the claims, to a kinked portion, a kinked cargo bay or cargo bay portion, a kinked cargo centerline, etc. will be understood by a person skilled in the art, in view of the present disclosures, to be referring to the aft end 140 of the aircraft 100 (or the aft end in other aircraft embodiments) in some instances.

Despite the angled nature of the aft end 140, the aft end 140 is well-suited to receive cargo therein. In fact, the aircraft 100 is specifically designed in a manner that allows for the volume defined by the aft end 140, up to almost the very aft-most tip of the aft end 140, i.e., the fuselage tail cone 142, can be used to receive cargo as part of the continuous interior cargo bay 170. Proximate to the fuselage tail cone 142 can be an empennage 150, which can include horizontal stabilizers for providing longitudinal stability, elevators for controlling pitch, vertical stabilizers for providing lateral-directional stability, and rudders for controlling yaw, among other typical empennage components that may or may not be illustrated but would be recognized by a person skilled in the art.

The aircraft 100 is particularly well-suited for large payloads because of a variety of features, including its size. A length from the forward-most tip of the nose cone 126 to the aft-most tip of the fuselage tail cone 142 can be approximately in the range of about 60 meters to about 150 meters. Some non-limiting lengths of the aircraft 100 can include about meters, about 84 meters, about 90 meters, about 95 meters, about 100 meters, about 105 meters, about 107 meters, about 110 meters, about 115 meters, or about 120 meters. Shorter and longer lengths are possible. A volume of the interior cargo bay 170, inclusive of the volume defined by the nose cone 126 and the volume defined in the fuselage tail cone 142, both of which can be used to stow cargo, can be approximately in the range of about 1200 cubic meters to about 12,000 cubic meters, the volume being dependent at least on the length of the aircraft 100 and an approximate diameter of the fuselage (which can change across the length). One non-limiting volume of the interior cargo bay 170 can be about 6850 cubic meters. Not accounting for the very terminal ends of the interior cargo bay 170 where diameters get smaller at the terminal ends of the fuselage 101, diameters across the length of the fuselage, as measured from an interior thereof (thus defining the volume of the cargo bay) can be approximately in the range of about 4.3 meters to about 13 meters, or about 8 meters to 11 meters. One non-limiting diameter of the fuselage 101 proximate to its midpoint can be about 9 meters. The wingspan, from tip of the wing 132 to the tip of the wing 134, can be approximately in the range of about 60 meters to 110 meters, or about 70 meters to about 100 meters. One non-limiting length of the wingspan 180 can be about 80 meters. A person skilled in the art will recognize these sizes and dimensions are based on a variety of factors, including but not limited to the size and mass of the cargo to be transported, the various sizes and shapes of the components of the aircraft 100, and the intended use of the aircraft, and thus they are by no means limiting. Nevertheless, the large sizes that the present disclosure both provides the benefit of being able to transport large payloads, but faces challenges due, at least in part, to its size that make creating such a large aircraft challenging. The engineering involved is not merely making a plane larger. As a result, many innovations tied to the aircraft 100 provided for herein, and in other commonly-owned patent applications, are the result of very specific design solutions arrived at by way of engineering.

Materials typically used for making fuselages can be suitable for use in the present aircraft 100. These materials include, but are not limited to, metals and metal alloys (e.g., aluminum alloys), composites (e.g., carbon fiber-epoxy composites), and laminates (e.g., fiber-metallic laminates), among other materials, including combinations thereof.

FIGS. 2B-2D provide for a general, simplified illustration of one exemplary embodiment of loading a large payload 10 into the aircraft 100. As shown, the cargo nose door 126 is swung upwards into its open position, exposing the portion of the interior cargo bay 170 associated with the fixed portion 128 of the fuselage 101, which can extend through the kinked portion 130 and through essentially the entirety of the aft end 140. The cargo opening 171 provides access to the interior cargo bay 170, and the cantilevered tongue 160 can be used to help initially receive the payload. As shown, the payload 10 includes two wind turbine blades 11A, 11B, held with respect to each other by payload-receiving fixtures 12. The payload-receiving fixtures 12 are generally considered part of the payload, although in an alternative interpretation, the payload 10 can just be configured to be the blades 11A, 11B. This payload 10 can be considered irregular in that the shape, size, and weight distribution across the length of the payload is complex, causing a center of gravity of the payload to be at a separate location than a geometric centroid of the payload. One dimension (length) greatly exceeds the others (width and height), the shape varies with complex curvature nearly everywhere, and the relative fragility of the payload requires a minimum clearance be maintained at all times as well as fixturing support the length of the cargo at several locations even under the payload's own weight under gravity. Additional irregular payload criteria can include objects with profiles normal to a lengthwise axis rotate at different stations along that axis, resulting in a lengthwise twist (e.g., wind turbine blade spanwise twist) or profiles are located along a curved (rather than linear) path (e.g., wind turbine blade in-plane sweep). Additionally, irregular payloads include objects where a width, depth, or height vary non-monotonically along the length of the payload (e.g., wind turbine blade thickness can be maximal at the max chord station, potentially tapering to a smaller cylinder at the hub and to a thin tip). The term irregular package will be similarly understood.

The payload 10, which can also be referred to as a package, particularly when multiple objects (e.g., more than one blade, a blade(s) and ballast(s)) are involved, possibly secured together and manipulated as a single unit, can be delivered to the aircraft 100 using most any suitable devices, systems, vehicles, or methods for transporting a large payload on the ground. A package can involve a single object though. In the illustrated embodiment, a transport vehicle 20 includes a plurality of wheeled mobile transporters 22 linked together by a plurality of spans, as shown trusses 24. In some instances, one or more of the wheeled mobile transporters 22 can be self-propelled, or the transport vehicle 20 more generally can be powered by itself in some fashion. Alternatively, or additionally, an outside mechanism can be used to move the vehicle 20, such as a large vehicle to push or pull the vehicle 20, or various mechanical systems that can be used to move large payloads, such as various combinations of winches, pulleys, cables, cranes, and/or power drive units.

As shown in FIG. 2B, the transport vehicle 20 can be driven or otherwise moved to the forward end 120 of the aircraft 100, proximate to the cargo opening 171. Subsequently, the payload 10 can begin to be moved from the transport vehicle 20 and into the interior cargo bay 170. This can likewise be done using various combinations of one or more winches, pulleys, cables, cranes, and/or power drive units, such set-ups and configurations being known to those skilled in the art. FIG. 2C illustrates a snapshot of the loading process with half of the fuselage removed for illustrative purposes (as currently shown, the half of the nose cone 126 illustrated is in both an open and closed position, but during loading through the cargo opening 171, it is in an open position). As shown, the payload 10 is partially disposed in the interior cargo bay 170 and is partially still supported by the transport vehicle 20. A distal end 10d of the payload 10 is still disposed in the forward end 120, as it has not yet reached the kinked portion 130.

The system and/or methods used to move the payload 10 into the partially loaded position illustrated in FIG. 2C can continue to be employed to move the payload 10 into the fully loaded position illustrated in FIG. 2D. As shown, the distal end 10d of the payload 10d is disposed in the interior cargo bay 170 at the aft end 140, a proximal end 10p of the payload is disposed in the interior cargo bay 170 at the forward end 120 (for example, on the cantilevered tongue 160, although the tongue is not easily visible in FIG. 2D), and the intermediate portion of the payload 10 disposed between the proximal and distal ends 10p, extends from the forward end 120, through the kinked portion 130, and into the aft end 140. As shown, the only contact points with a floor of the interior cargo bay 170 (which for these purposes includes the tongue 160) are at the proximal and distal ends 10p, 10d of the payload 10 and at two intermediate points 10j, 10k between the proximal and distal ends 10p, each of which is supported by a corresponding fixture 12. In other embodiments, there may be fewer or more contact points, depending, at least in part, on the size and shape of each of the payload and related packaging, the size and shape of the cargo bay, the number of payload-receiving fixture used, and other factors. This illustrated configuration of the payload disposed in the interior cargo bay 170 is more clearly understood by discussing the configuration of the kinked fuselage (i.e., the fuselage 101 including the kinked portion 130) in greater detail. Once the payload 10 is fully disposed in the interior cargo bay 170, it can be secured within the cargo bay 170 using techniques provided for herein, in commonly-owned applications, or otherwise known to those skilled in the art.

### Kinked Fuselage

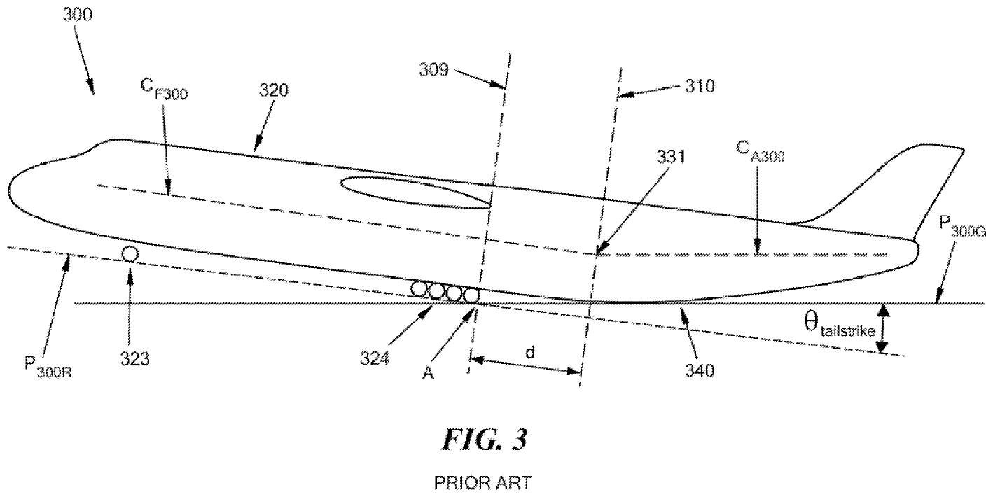

FIG. 3 is an illustration of a prior art aircraft 300 during a takeoff pitch-up maneuver showing the calculating of a tailstrike angle (θₜₐᵢₗₛₜᵣᵢₖₑ), which is determined when a forward end 320 of the aircraft 300 is lifted away from the ground P_{300G} (e.g., a runway of an airport) and an aft end 340 and tail of the aircraft 300 is pushed towards the ground 50 until contact. This change occurs during a takeoff pitch-up maneuver when the aircraft 300 pitches (e.g., rotates) about a lateral axis of rotation, indicated as “A” in FIG. 3. This lateral axis of rotation, A, is typically defined by the main landing gear 324, which acts as a pivot point to allow a downwards force generated by the tail to lift the forward end 320 of the aircraft 300. In FIG. 3, the nose landing gear 323 and main landing gear 324 of the aircraft 300 define a resting plane P 300R (e.g., plane horizontal with the ground plane P 300G when the aircraft is resting), such that the tailstrike angle θₜₐᵢₗₛₜᵣᵢₖₑ can be defined by the change in the angle of the ground plane P_{300G} with respect to the resting plane P_{300R} when the aircraft 300 has achieved a maximal pitch angle or takeoff angle, which occurs just before any part of the aft end 340 of the aircraft 300 strikes the ground. In FIG. 3, a forward center line C_{F300} of the aircraft 300 is shown, along with an aft centerline C_{A300}, which extends to the aft end 340 of the aircraft 300. In order to increase θₜₐᵢₗₛₜᵣᵢₖₑ, larger aircraft 300 usually have an upsweep to the lower surface of an aft region of the aft fuselage. This upsweep deflects the centerline C_{A300} with respect to the forward center line C_{F300} at the initiation of the upsweep, which is shown in FIG. 3 as a bend 331 in the centerlines C_{F300}, C_{A300}. In prior art aircraft 300, this bend 331 occurs a certain distance, shown in FIG. 3 as distance “d” aft of the lateral axis of rotation A. Longer values of distance “d” increase the constant cross-section length of the aircraft 300, which can, depending on the type of aircraft, extend the length of a passenger cabin and/or increase the length of the cargo bay, and thus the ability to carry cargo of an increased maximum length. Aspects of the present disclosure eschew this prior art incentive for increasing distance “d” and instead significantly reconfigure the relationship between the aft fuselage and forward fuselage such that decreasing distance “d” can result in increasing the maximum usable cargo bay length, as explained in more detail below.

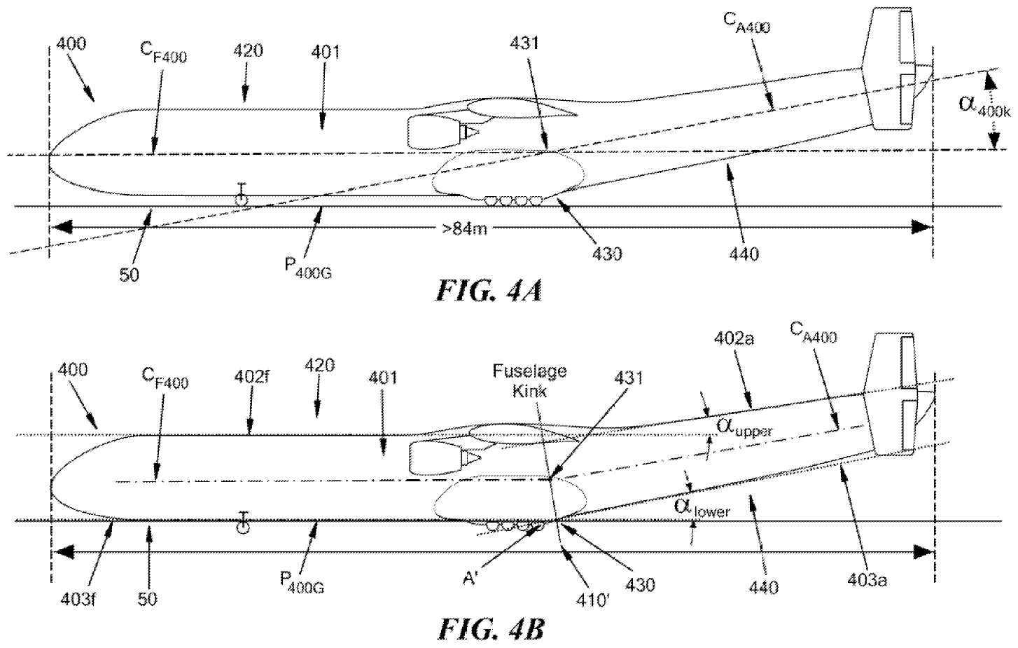

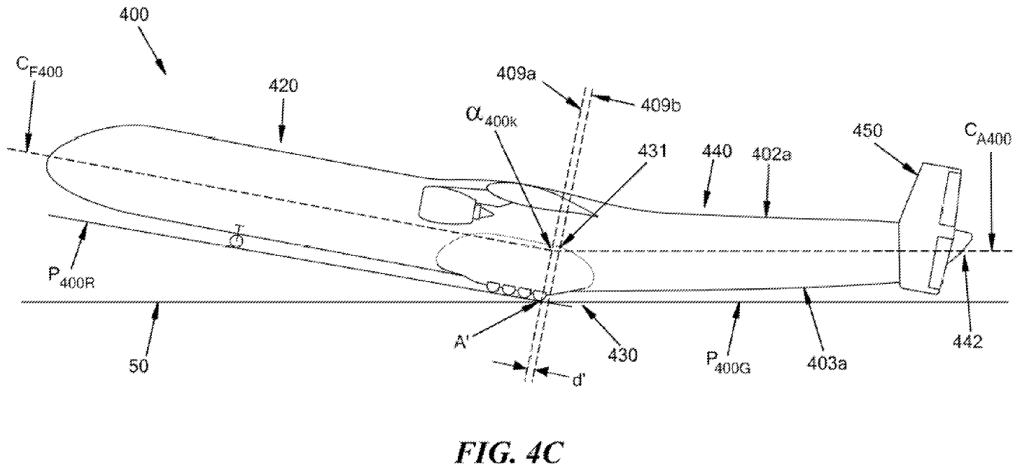

FIG. 4A is a side view illustration of an exemplary cargo aircraft 400 of the present disclosure. The aircraft 400, which is shown to be over 84 meters long, includes a fuselage 401 having a forward end 420 defining a forward centerline C_{F400} and an aft end 440 defining an aft centerline C_{A400}, with the aft centerline C_{A400} being angled up with respect to the forward centerline C_{F400}. The forward and aft centerlines C_{F400}, C_{A400} define a junction or kink 431 therebetween, where the forward centerline C_{F400} angles upward as the overall aft fuselage, which is in the aft end 440, changes in direction to be angled with respect to the forward fuselage, which is in the forward end 420. This defines a kink angle α_{400K} of the aft fuselage 440. The kink location 431 is contained in the kinked portion 430 disposed between and connecting the forward and aft ends 420, 440. FIG. 4B shows the forward centerline C_{F400} as being an approximate midpoint between a top-most outer or upper surface 402f and a bottom-most outer or lower surface 403f of the fuselage 401 forward of a lateral axis of rotation A′, with the aft centerline C_{A400} being an approximate midpoint between an upper surface 402a and a lower surface 403a of the fuselage 401 aft of the lateral axis of rotation. FIG. 4B shows the kink 431 between the forward centerline C_{F400} and the aft centerline C_{A400} as being an approximate change in the angle of a plane 410′ substantially perpendicular to the centerline C_{F400} and most of the upper and lower surfaces 402a, 403a extending aft from the kink 431, such that the fuselage 401 aft of the kink 431 has a substantial portion of an approximately constant height or cross-sectional area. This represents only one example, and in other instances the upper surface 402a does not necessarily extend approximately parallel to the lower surface 402b at all even if the aft fuselage still defines a kink 431 in the centerline.

In FIG. 4B, the angle of the aft centerline C_{A400} with respect to the forward centerline C_{F400} defines a kink or bend angle (illustrated as α_{400K} (in FIG. 4A), which can be approximately equal to average of an angle αᵤₚₚₑᵣ of the after upper surface e 402a and an angle α_{lower} of the lower surface 403a with respect to the forward centerline C_{F400} and forward upper and lower surfaces 402f, 403f for the case of a constant cross-section forward fuselage 401, as shown in FIG. 4B (hence, FIG. 4B indicating the upper and lower surfaces 402a, 403a defining the respective upper and lower angles αᵤₚₚₑᵣ, α_{lower}) In some instances, the angles αᵤₚₚₑᵣ, α_{lower} of the aft upper and lower surfaces 402a, 403a vary with respect to the angle of the aft centerline C_{A400}, with the location of a substantial upward deflection in the overall centerline (e.g., kink 431) being defined by the overall shape and slope of the aft fuselage with respect to the forward fuselage (or more generally the overall shape and slope of the aft end 440 with respect to the forward end 420). For example, for the aircraft 100 of FIG. 1B, the lower surface defines a lower angle α_{lower}, which is approximately equal to the tailstrike angle of approximately 12 degrees, and the upper surface angle αᵤₚₚₑᵣ in the aft fuselage is approximately between 6 and 7 degrees. In some exemplary embodiments, the result kink angle of the aft centerline C_{A400} can be approximately in the range of about 0.5 degrees to about 25 degrees, and in some instance it is about 10 degrees with respect to a longitudinal—lateral plane of the cargo aircraft 100, i.e., a plane in which the forward centerline C_{F400} is disposed, the plane extend substantially parallel to the ground or a ground plane P_{400G} Further, the kink angle α_{400K} (can be approximately equal to a degree of maximal rotation of the aircraft during the takeoff operation. Still further, a length of the aft end 140, i.e., the portion that is angled with respect to the forward centerline C_{F400}, can be approximately in the range of about 15% to 65%, and in some instances about 35% to about 50% of a length of the entire fuselage 101, and in some embodiments it can be about 49% the length of the fuselage 101.

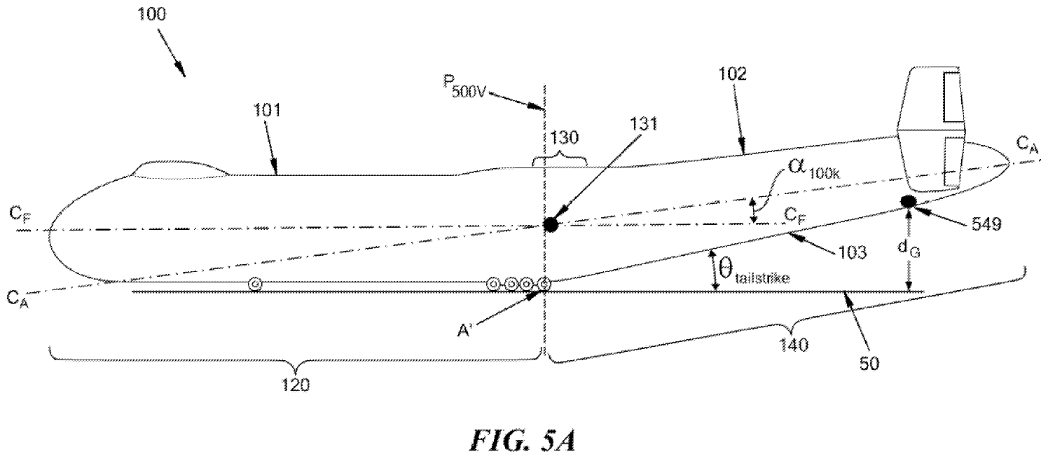

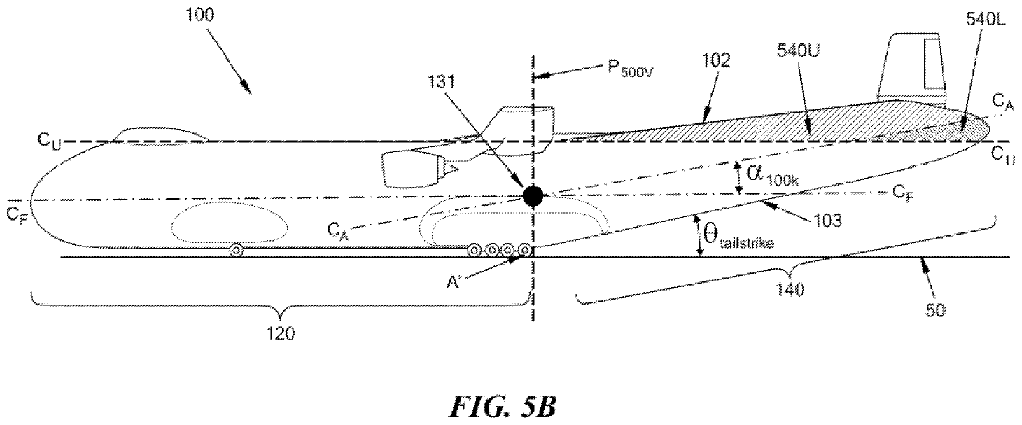

In FIG. 4C, the cargo aircraft 400 is shown on the ground 50 and rotated about the lateral axis of rotation to illustrate, for example, a takeoff pitch-up maneuver. In FIG. 4C, a resting plane P_{400R} of the forward end 420 angled with respect to the ground or ground plane P_{400G} at a degree just before θₜₐᵢₗₛₜᵣᵢₖₑ, as no part of the aft end 440, empennage 450, or tail 442 is contacting the ground. In this position, the lower surface 403a (and, approximately, the aft centerline C_{A400}) is substantially parallel with the ground or ground plane P_{400G}, and it can be seen that because the location of the centerline kink 431 of the kinked portion 430 is approximately with, or very close to, the lateral axis of rotation A′, the angle α_{400K} (of the kink 431 is approximately the maximum safe angle of rotation of the aircraft 400 about the lateral axis of rotation A′. FIG. 4C shows a vertical axis 409a aligned with the location of the lateral axis of rotation A′ and another vertical axis 409b aligned with the kink 431 in the fuselage centerline C_{F400}, with a distance d′ therebetween. With d′ being small, and the lower surface 403a of the aft end 440 extending aft with approximately the kink angle α_{400K} (of the kink 431 or a slightly larger angle, as shown, the aft end 440 is highly elongated without risking a tail strike. Accordingly, minimizing d′ approximately sets the lower angle α_{lower} as an upper limit to the safe angle of rotation about the lateral pitch axis. Moreover, the upward sweep of the upper surface 402a can be arranged to maintain a relatively large cross-sectional area along most of the aft end 440, thereby enabling a substantial increase in the overall length of the cargo aircraft 400, and thus usable interior cargo bay within the aft end 440, without increasing θₜₐᵢₗₛₜᵣᵢₖₑ. FIG. 5A shows this in further detail for the cargo aircraft 100 of FIG. 1A.

In FIG. 5A, the aft centerline C_{A} and forward centerline C_{F} of the fuselage 101 are shown intersecting at a kink location 131 just aft of the vertical plane P_{500V} of the lateral axis of rotation A′, which occurs within the kinked portion 130 connecting the forward end or fuselage 120 to the aft end or fuselage 140. The lower surface 103 of the aft fuselage 140 approximately defines θₜₐᵢₗₛₜᵣᵢₖₑ of the cargo aircraft 100, which is slightly larger than a kink angle α_{100K} defined by the upslope of the aft centerline C_{A} with respect to the forward centerline C_{F}. Additionally, in some examples, the aft fuselage can include a sensor 549 configured to measure the distance d_{G} of the lower surface 103 of the aft fuselage 140 to the ground 50 to assist the pilot and/or computer in control of the aircraft 100 in maximally rotating the aircraft 100 about the lateral pitch axis without tailstrike.

As explained in more detail below, vertically aligning the kink location 131 with the lateral pitch axis can enable the aft fuselage 140 to extend without decreasing θₜₐᵢₗₛₜᵣᵢₖₑ, which also can enable the useable portion of the interior cargo bay 170 to extend aft along a substantial portion of the aft fuselage 140. Further, the present designs can enable the creation of extremely long aircraft designs capable of executing takeoff and landing operations with shorter runway lengths than previously possible. These lengths can be the equivalent of existing typical runway lengths, or even shorter, which is surprising for an airplane that is longer. Runway lengths approximately in the range of about 500 meters to about 1000 meters are likely possibly in view of the present disclosures, as compared to existing runways, which are about 2000 meters for standard aircraft and about 3000 meters for larger aircrafts. Thus, the engineering related to the aircraft 100, 400, and other embodiments of aircraft derivable from the present disclosures, enable extremely large aircraft that can be used on runways that are the smaller than runways for aircraft that are considered to be large aircraft due, at least in part, to the designs enabling increased pitch angles without causing tailstrike.

A further advantage provided by the present designs is being able to maintain the location of the center-of-gravity of the aircraft close to the lateral pitch axis, which minimizes the downforce required by the tail to rotate the aircraft during takeoff. This minimization of necessary downforce allows pitch-up maneuvers to occur at slower speeds, thereby increasing the available angle of attack (and thus lift) able to be generated at a given speed, which in turn reduces the speed necessary to generate enough lift to get the aircraft off the ground. This advantage is not achievable in prior art designs that attempt to increase their cargo length efficiency (e.g., maximum linear payload length as a function of overall fuselage length) at least because: (1) a reduction in tailstrike angle as the aft fuselage is elongated aft of the lateral rotation axis (e.g., in designs with an aft fuselage bend location being a substantial distance from their lateral axis of rotation); (2) a reduced ability to complete a pitch-up maneuver at low-speeds if the lateral pitch axis is moved aft of the center-of-gravity of the aircraft to accommodate the elongated fuselage, necessitating a substantial increase in wing and/or tail size to achieve the takeoff lengths equal to aircraft designs having lateral pitch axis closer to their center-of-gravity; and/or (3) a reduction in the cargo bay diameter as the aft end of the cargo bay is extended further toward the tail.

FIG. 5B shows the vertical extension of the aft fuselage 140 above the forward portion 120 of the fuselage 101. In FIG. 5B, a line Cᵤ is drawn showing the approximately horizontal extension of the upper surface of the forward portion 120 of the fuselage 101. A substantial portion of the aft portion 140 of the fuselage extends above this line Cᵤ. This includes an upper portion 540U of the aft portion 140 that is above both the line Cᵤ and the aft centerline C_{A} and a lower portion 540L that is above the both the line Cᵤ and below the aft centerline C_{A}. The size of the upper and lower portions 540U, 540L depends on the kink angle α_{100K}, the length of the aft portion 140, and one or both of the upper and lower angles αᵤₚₚₑᵣ, α_{lower}, as these together define the kink angle α_{100K} and the height of the of the aft portion 140 as it extends to the aft end. In some examples, a substantial portion of both the upper and lower portions 540U, 540L is occupied by a portion of the interior cargo bay 170.

FIG. 6A is side cross-section view of the cargo aircraft 100, the cross-section being taken along an approximate midline T-T of the top-most outer surface, as shown in FIG. 1A. The cargo bay 170 defines a centerline that extends along the overall length of the cargo bay 170. The cargo bay 170 extends from a forward end 171 of a forward end or region 170f of the cargo bay 170, as shown located in the nose cone 126, to an aft end 173 of an aft end or region 170a of the cargo bay 170, as shown located in the fuselage tail cone 142. The forward and aft regions 170f, 170a of the cargo bay 170 sit within the forward and aft ends 120, 140, respectively, of the aircraft 100. More particularly, the forward region 170f can generally define a forward cargo centerline C_{FCB} that can be substantially colinear or parallel to the forward fuselage centerline C_{F} (shown in FIG. 5A) and the aft region 170a can generally define an aft cargo centerline C_{ACB} that can be substantially colinear or parallel to the aft fuselage centerline C_{A} (shown in FIG. 5A). Accordingly, in the kinked portion 130 of the fuselage 101, which itself can include a comparable kinked portion 170k of the cargo bay 170, where the aft fuselage centerline C_{A} bends with respect to the forward fuselage centerline C_{F}, the aft cargo centerline C_{ACB} also bends at a kink location 631 with respect to the forward cargo centerline C_{FCB}. The bend can be at approximately the same angle, as shown an angle α_{100KP}, as the kink angle α_{100K} of the fuselage 101. The aft cargo centerline C_{ACB} can extend at least approximately 25% of a length of a centerline of the continuous interior cargo bay 170, i.e., the length of the centerline throughout the entire cargo bay 170. This amount more generally can be approximately in the range of about 25% to about 50%. There are other ways to describe these dimensional relationships as well, including, by way of non-limiting example, a length of the aft cargo centerline C_{ACB} being at least approximately 45% of the length of the fuselage 101 and/or at least approximately 80% of a length of the fuselage 101 aft of the lateral pitch axis, among other relationships provided for herein or otherwise derivable from the present disclosures.

FIG. 6A shows the aft region 170a of the cargo bay 170 extending through almost all of the aft fuselage 140, which is a distinct advantage of the configurations discussed herein. Moreover, due to the length of the aft fuselage 140, a pitch 674 of structural frames 104a of the aft fuselage 140 can be angled with respect to a pitch 672 of structural frames 104f of the forward fuselage 120 approximately equal to the kink angle α_{100K} of the fuselage 101. In some examples, the kinked region 130 represents an upward transition between the pitch 672 of the structural frames 104f of the forward fuselage 120 and the pitch 674 of the structural frames 104a of the aft fuselage 140. A person skilled in the art will recognize that structural frames 104a, 104f are merely one example of structural features or elements that can be incorporated into the fuselage 101 to provide support. Such elements can be more generally described as circumferentially-disposed structural elements that are oriented orthogonally along the aft centerline C_{ACB} and the forward centerline C_{FCB}. In some examples, the location of the cargo bay kink 631 (FIG. 6A) is forward or aft of the fuselage kink 131 (FIG. 5A) such that either the forward cargo region 170f partially extends into the aft fuselage 140 or the aft cargo region 170a partially extends into the forward fuselage 120, however, this generally depends, at least in part, on the distance between the interior of the cargo bay 170 and the exterior of the fuselage, which is typically a small distance for cargo aircraft having a maximally sized cargo bay. Regardless, to fully utilize examples of the present disclosure, the aft region 170a of the cargo bay 170 can be both (1) able to be substantially extended due to the ability of the aft fuselage 140 length to be extended and (2) able to extend along substantially all of the length of the aft fuselage 140 because examples of the present disclosure enable aircraft to have elongated aft fuselages for a fixed tailstrike angle and/or minimized kink angle. Additionally, minimizing the fuselage kink angle for elongated aft fuselages allows the aft region of the cargo bay to extend further along the fuse fuselage while increasing the maximum straight-line payload length for a given overall aircraft length and tailstrike angle, as shown at least in FIGS. 6B and 6C.

Additional information regarding the kinked fuselage and the structural transition between forward and aft fuselage regions are provided in International Patent Application No. PCT/US2021/021792, entitled “AIRCRAFT FUSELAGE CONFIGURATIONS FOR UPWARD DEFLECTION OF AFT FUSELAGE,” and filed Mar. 10, 2021, and the content of which is incorporated by reference herein in its entirety.

FIG. 6B shows a side cross-sectional view of the fuselage 101 of the cargo aircraft 100 of FIG. 6A with a highly elongated payload 10 of two wind turbine blades 11A, 11B disposed substantially throughout the interior cargo bay 170 and extending from the forward end 171 of the forward region 170f to the aft end 173 of the aft region 170a. Having at least a portion of the aft region 170a being linearly connected to (e.g., within line of sight) of at least a portion of the forward region 170f enables the extension of the aft region 170a to result in an extension in the maximum overall length of a rigid payload capable of being carried inside the interior cargo bay 170. Wind turbine blades, however, are often able to be deflected slightly during transport and so examples of the present disclosure are especially suited to their transport as the ability to slightly deflect the payload 10 during transport enables even long maximum payload lengths to be achieved by further extending the aft end 173 of the aft region 170a beyond the line of sight of the forward-most end 171 of the forward region 170f.

FIG. 6C is the same cross-sectional view of the fuselage 101 of the cargo aircraft 100 of FIG. 6B with a maximum length rigid payload 90 secured in the cargo bay 170. A forward end 90f of the maximum length rigid payload 90 can be secured to the cantilevered tongue 160 in the forward end 171 of the forward region 170f with a first portion of the weight of the payload 90 (shown as vector 91A) being carried by the cantilevered tongue 160 and an aft end 90a of the maximum length rigid payload 90 can be secured to the aft end 173 of the aft region 170a with a second portion of the weight of the payload 90 (shown as vector 91B) being carried by the aft end 173 of the aft region 170a.

FIG. 6D is the same cross-sectional view of the fuselage 101 of the cargo aircraft 100 of FIG. 6A with a maximum weight payload 92 secured in the cargo bay 170. A forward end 92f of the maximum weight payload 92 can be secured in the forward region 170f of the interior cargo bay 170 with a first portion of the weight of the payload 92 (shown as vector 93A) being carried by the forward fuselage 120 and an aft end 92a of the maximum weight payload 92 can be secured in the aft region 170a of the interior cargo bay 170 with a second portion of the weight of the payload 92 (shown as vector 93B) being carried by the aft fuselage 140. Advantageously, the substantial length of the cargo bay 170 forward and aft of the a center-of-gravity of the aircraft 100 (e.g., approximately aligned with the kinked region 130) enables positioning of the maximum weight payload 92 such that the payload center-of-gravity (shown as vector 94) substantially close (i.e., within about 30% of wing Mean Aerodynamic Cord (MAC) or about 4% of total aircraft length) to or aligned with the center-of-gravity of the aircraft 100. In some examples, at least about 10% of the weight of maximum weight payload 92 is carried in the aft region 170a. In some examples of carrying a maximum weight payload, especially payloads approaching a maximum length, about 40% to about 50% could be carried in the aft region 170a in order to center the payload's center of gravity at a nominal location in the cargo bay 170.

FIG. 7 is a perspective view of the cargo aircraft 100 of FIG. 6A showing a lower support system 190A, 190B that extends along the cargo bay 170 from a forward entrance 171 to and through the aft section 170a (not visible) of the cargo bay 170 in the aft portion 140 (not visible) of the fuselage 101. The lower support system 190A, 190B can include forward portions 191A, 191B that extend forward along the cantilevered tongue 160 as well. In some examples, the lower support system 190A, 190B includes rails or tracks, or similar linear translation components, that enable a payload to be translated into the cargo bay 170 and all the way to the aft end of the aft region 170a of the cargo bay 170 from the cargo opening 171, for instance by having the lower support system 190A, 190B extend through nearly an entire length of the fixed portion 128 of the fuselage 101. In some examples, the lower support system 190A, 190B can be used to support and/or the payload during flight such that the lower support system 190A, 190B can hold substantially all of the weight of the payload.

Additional details about tooling for cargo management, including rails and payload-receiving fixtures and fuselage configuration for enabling loading and unloading of payloads into aft regions of a continuous interior cargo bay are provided in International Patent Application No. PCT/US2020/049784, entitled “SYSTEMS AND METHODS FOR LOADING AND UNLOADING A CARGO AIRCRAFT,” and filed Sep. 8, 2020, and the content of which is incorporated by reference herein in its entirety.

### Kinked Fuselage—Structural Transition Zone

In contrast to previous solutions that utilize a complex single wedge frame to connect two constant-section semi-monocoque fuselage structures together, and thereby drive all the complexity into that single wedge frame to keep complexity out of the two adjoining fuselage structures, examples of the present disclosure enable complex fuselage changes (e.g., the forward-to-aft kink or bend angle in the fuselage and interior cargo bay centerline) to over multiple transverse frames and longitudinally continuous skin panels. The examples of the present disclosure thus reduce the overall structural complexity transition zone between more simply shaped forward and aft fuselage sections.

Examples of the present disclosure provide for an entire semi-monocoque kinked transition section that can be constructed from multiple transverse frames, multiple skin panel segments, and stringers, with compound curvature skins to bridge the gap between two fuselage sections with different frame angles. Examples of the presently described transition section can be “plugged” in between forward and aft fuselage sections and can therefore be connected to a forward fuselage portion via a standard transverse frame (e.g., a ring frame that circumscribes the fuselage), and can likewise be connected to an aft fuselage portion via a different, but similarly standard, transverse frame oriented at an angle to accommodate the overall bend in the fuselage that occurs across the transition zone (i.e., the kinked portion of the fuselage that extends longitudinally between the transverse frame at the aft end of the forward portion and the transverse frame at the forward end of the aft portion), where most or all of the transverse frame sections of the forward portion are aligned in parallel and, similarly, most or all of the transverse frame sections of the aft portion are also aligned in parallel to each other and also at an angle (e.g., the bend angle) with respect to the transverse frame sections of the forward portion. However, examples of the present disclosure include transition sections that can be a unitary structure with forward and aft fuselage sections, such that the end frames of the forward and aft fuselage sections are also beginning frames of the transition section, or, alternatively one or more of the forward and aft fuselage sections and the transition section can be constructed as entire sub-segments that are joined together during a final assembly of the entire fuselage. The change in fuselage angle between the forward and aft transverse frames within the transition zone can occur over longitudinally continuous skin panels to reduce complexity of the angle change joint. In other words, aspects of the present disclosure can reduce the complexity of each single fuselage joint and frame compared with solutions where the fuselage bend occurs across any one single frame. Accordingly, examples of the present disclosure can instead add more complexity to the skin panels by extending the fuselage bend across two or more transverse frame sections, with curved, bent, and/or tapered longitudinal panels and/or frame stringers extending therebetween.

Additional details about the fuselage transition region are provided in International Patent Application No. PCT/US21/21792, entitled “AIRCRAFT FUSELAGE CONFIGURATIONS FOR UPWARD DEFLECTION OF AFT FUSELAGE,” and filed Mar. 10, 2021, and the content of which is incorporated by reference herein in its entirety.

Controlling Aerodynamic Drag with Symmetric Control Surfaces

Examples of the present type of transport-category aircraft (e.g., aircraft 100 of FIG. 1A) are, of necessity, an extraordinarily large air vehicle with an extraordinarily long cargo bay and fuselage. As air vehicles get larger and longer, deceleration without large field lengths becomes increasingly difficult.

One aspect of the aircraft examples of the present disclosure involves short takeoff and landing (STOL) field performance that allows origin and destination field lengths that are significantly shorter than traditional runways. During takeoff, a critical consideration involves the additional amount of runway required to decelerate to stop after an engine failure that occurs just prior to takeoff rotation, and this consideration may drive runway sizing. Additionally, during landing, an aircraft must have sufficient runway distance to stop with a regulated amount of margin. The required runway size, and corresponding cost, that need to be developed at various origins for cargo and destinations may be reduced significantly by increasing the capability of the aircraft to decelerate at higher rates.

Additionally, there are various regulations that govern the ability for large aircrafts to operate at higher, more efficient and faster cruising altitudes, as well as the ability of the aircraft to operate into higher-traffic urban airports. To operate at higher altitudes, large aircraft (subject to FAR part 25) must be capable of descending quickly to low altitudes in the event of a cabin depressurization event. To operate into certain airports, aircraft must be capable of achieving steep descent angles to avoid creating the noise, approaching manmade or natural features on the ground, or violating similar spatial restrictions associated with low-angle approaches over densely populated or otherwise protected areas. A drag level of an aircraft is closely related to all of these measures of performance During ground deceleration, aerodynamic drag is typically a secondary force that supplements the primary braking forces. During descents to lower altitudes, aerodynamic drag is typically the primary force that bleeds off potential energy due to aircraft altitude.

In general terms, aircraft flight control systems (e.g., elevators, ailerons, and rudders, respectively) create a pitching, rolling, or yawing moment by generating asymmetric forces on opposite sides of the corresponding aircraft axis (e.g., pitch, roll, or yaw). More specifically, elevators can primarily control a pitching moment, ailerons can primarily control a rolling moment, and rudders can primarily control a yawing moment. In the context of the present disclosure, these three moments can be considered “aircraft level moments” with the elevator(s) and rudder(s) being part of an empennage such that they are considered “empennage control surfaces” and the aileron(s) being part of a wing(s) such that they are considered “wing control surfaces.” The yawing moment can be the moment that acts to rotate the aircraft to a nonzero sideslip angle (nose-left or nose-right) about the vertical Z axis through the aircraft reference location (may be center of gravity). The pitching moment can act to rotate the aircraft to a nonzero angle of attack (nose-up or nose-down) about the horizontal Y axis through the reference location and going out the starboard wing. Finally, the rolling moment can act to rotate the aircraft to a nonzero bank angle (starboard wing up or starboard wing down) about a horizontal X axis through the reference location. There are many examples of aircraft that mix these axes with joined or hybrid controls (e.g., ruddervators on V-tail aircraft). However, examples of the present disclosure include methods and control systems that utilize these aft controls surface in a system that creates drag but no other control effect.

FIG. 8A is an isometric view of the aircraft 100 of FIG. 1A showing resultant control surface forces about the center of gravity and a detail view of the empennage 150 showing control surface movement. FIG. 8A shows an aircraft 100 constructed in accordance with the present disclosure utilizes four rudders (visible in Detail A: an upper port rudder 821p, a lower port rudder 822p, an upper starboard rudder 821s, and a lower starboard rudder 822s) on respective port and starboard vertical stabilizer sections 820p, 820s of the empennage 150. The rudder configuration is capable of generating additional drag to supplement ground deceleration or flight descent rate and angle, for example by deflecting the empennage rudder control surfaces 821p, 822p, 821s, 822s symmetrically outboards (e.g., two port rudders 821p, 822p in the trailing-edge-port direction and two starboard rudders 821s, 822s in the trailing-edge-starboard direction, and as shown in FIG. 8B) or symmetrically inboards (two port rudders 821p, 822p in the trailing-edge-starboard direction and two starboard rudders 821s, 822s in the trailing-edge-port direction).

FIG. 8A illustrates an example of a standard control system with rudders 821p, 822p, 821s, 822s that deflect in a direction to act together to generate yawing moment 891. FIG. 8A shows a traditional rudder command input with the port and starboard rudders 821p, 822p, 821s, 822s moving in identical directions: all rudders moving with their trailing edges towards port (as indicated by arrows 821pd, 822pd, 821sd, and 822sd). In this configuration of FIG. 8A, the port rudders 821p, 822p generate a resultant port control force PCF on the port vertical stabilizer 820p in the same direction as a starboard control force SCF that is generated on the starboard vertical stabilizer 820s by the starboard rudders 821s, 822s. Together, the port and starboard control forces PCF, SCF yaw the aircraft 100 about a vertical axis 890 that passes through the center of gravity 899 of the aircraft 100. A small drag force 881 is imparted on the aircraft 100, but the significant distance of the empennage 150 from the center of gravity 899 typically means that small rudder 821p, 822p, 821s, 822s deflections generate significant yaw 891, and, because the drag force 881 has no moment arm advantage, the drag force 881 is only a function of the degree of deflection of the rudders. The drag force 881 is typically quite small for traditional rudder deflections across the range of normal yaw commands. FIG. 8A also shows that the empennage 150 has an H-type configuration, with the vertical stabilizers 820p, 820s disposed laterally apart from the aft portion 140 of the fuselage 101 by horizontal stabilizers 810p, 810s that each include elevators 840 for controlling the pitch of the aircraft 100.

FIG. 8B illustrates an example of control surfaces configured for operation in accordance with the present disclosure. FIG. 8B, in Detail B, shows an example of the rudders 821p, 822p, 821s, 822s deflecting in opposite directions and thereby generating no rotational control effect about the center of gravity 899 of the aircraft 100, but increasing drag to decelerate more quickly. In this configuration, the rudders 821p, 822p, 821s, 822s are deflecting trailing-edge-outboards (e.g., port on port rudders 821p, 822p, starboard on starboard rudders 821s, 822s) with no yawing moment being generated due, at least in part, to the port and starboard control forces PCF, SCF′ being equal and opposite, but with a significant increase in the aircraft trim drag 882. In comparison with FIG. 8A, in FIG. 8B, the starboard control force SCF′ is directed inward (e.g., towards the centerline of the aircraft 100) by changing the orientation of the starboard rudder deflection 821sd′, 822sd′ from a trailing-edge-inward orientation (as shown in FIG. 8A) to a trailing-edge-outward orientation. The resulting symmetric deflecting of the rudders 821p, 822p, 821s, 822s can cause all of their yawing moment contributions to cancel one another, but still generate a drag component commonly known as trim drag (e.g., by extending the control surfaces of the rudder outwards into the oncoming flow, as well as by pushing airflow through a constricted, torturous flow path through the control surface cove, and also by generating or strengthening vortices at the tips of the control surface). In this configuration, increasing the deflections of the rudders 821p, 822p, 821s, 822s is possible to increase the drag force 882 and without generating additional control forces. Similar actions can be taken in conjunction with other empennage control surfaces, such as elevators 840, and/or wing control surfaces, such as ailerons 870. For example, one or more elevator trailing edges can be deflected upwards and one or more elevator trailing edges can be deflected downwards to achieve a zero pitching moment, but still result in additional drag 882. Likewise, by way of further example, two aileron 870 trailing edges can be deflected trailing edge up to achieve a zero rolling moment but still drag and provide a downforce. Control surfaces that impact aircraft level moments can be disposed symmetrically about a longitudinal axis of the aircraft to provide symmetry for the aircraft.

FIG. 8C illustrates an alternative embodiment of the present disclosure in which an example control system still achieves controllability by decreasing the deflections of one control surface out of the pair of control surfaces to maintain the ability to provide control. In this example, the rudders 821p, 822p, 821s, 822s are initially deflected trailing-edge-outboards with no yawing moments, but there can be a significant drag increase, as in the example of FIG. 8B. The starboard control force SCF″ can be reduced by reducing the starboard rudder deflection 821sd″, 822sd″ towards a neutral deflection while generating an increased drag 883. Then, optionally, deflection can be reduced, for example toward an increasingly trailing-edge-starboard deflection (not shown), to achieve control of the yawing moment 893 of the aircraft 100 while the port rudders 821p, 822p maintain a deflected position, thereby increasing the drag 883 on the aircraft 100. The inverse motion is possible as well, with a maximum starboard control force and drag fraction being maintained and the resulting yawing moment 893 direction being reversed from that illustrated in FIG. 8C. Accordingly, in at least some instances, at least 50% of the maximum rudder drag can be maintained at all times while achieving full yaw control over the aircraft 100.

The illustrations of FIGS. 8A-8C depict structural and control surface aspects of the example aircraft 100 and methods of movement of the control surfaces and aircraft. Examples of the present disclosure include control systems configured to actuate the control surfaces discussed herein and manually or automatically execute the increased drag control surface movements while, in at least some instances, maintaining control of the aircraft movements. Such control can include adjustment of the control surfaces to cause the increase in trim drag, sometimes referred to herein as speedbraking.

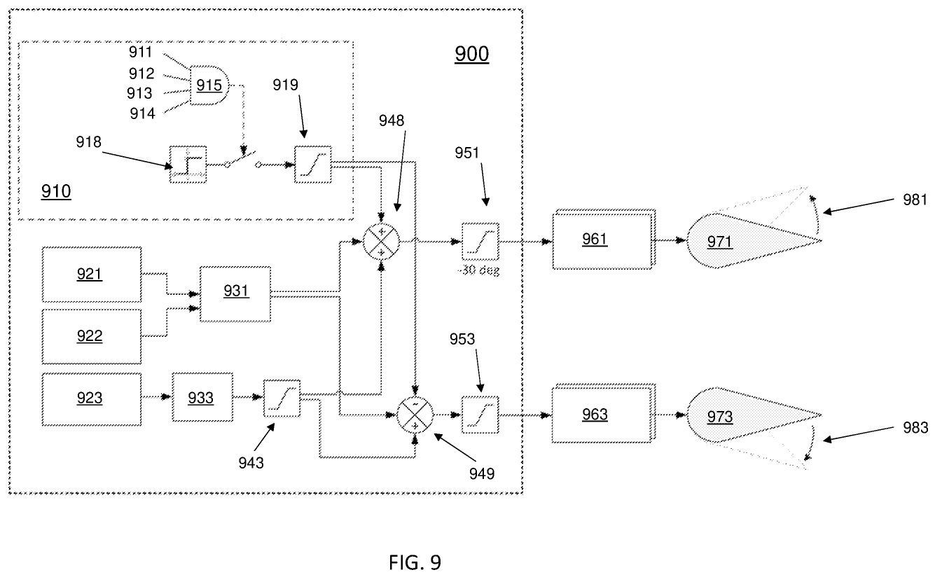

FIG. 9 is a schematic of a control system configured to conduct symmetric rudder speedbraking and illustrating how, during commanded yaw control inputs, the rudder segments on one side or another can decrease their portion of the symmetric deflection to regain the intended effect of generating yawing moment in response to the control input.

Examples of the present disclosure are embodied in an aircraft control system 900 that has components 971, 973 (e.g., rudders) capable of generating forces and moments on opposite sides of a primary aircraft axis (e.g., pitch, roll or yaw). The separate components 971, 972 can be disposed on opposite sides of the aircraft to: (1) achieve capability of acting symmetrically in opposite directions in a way that generates drag but does not contribute to the traditional control purpose of the surface by generating a mean, total moment about the primary aircraft axes (pitch, roll or yaw) because moment contributions of the components cancel one another; and (2) maintain control capability to generate moments about the primary aircraft axes (e.g., pitch, roll or yaw) by means of reducing the control action on one side of the primary aircraft axis or the other.

Actions taken to impact aircraft level moments, such as movement of an empennage control surface(s) and/or a wing control surface(s) can be referred to as movements or maneuvers. More specifically, such movements can be referred to as yawing, pitching, and/or rolling movements or maneuvers.

The actions provided for herein, such as deflecting empennage control surfaces, can take place during a landing operation of the aircraft. This can allow the resultant drag force to at least partially reduce a groundspeed of the aircraft to a touchdown speed. It can also occur after a touchdown operation to allow the resultant drag force to at least partially reduce a groundspeed of the aircraft to a taxi speed and/or to a stop. Still further, the actions can be useful after a rejected takeoff (RTO), such as when an engine is lost on takeoff and the takeoff is aborted such that the aircraft needs to be stopped before the end of the runway rather than continuing to takeoff. Additionally or alternatively, the drag force created by the present disclosures can increase a descent rate during flight operations.

Although illustrated examples presented herein show an aircraft with four rudders, the same principles can be applied to aircraft with two rudders, three rudders, five or more rudders, or any number of control surfaces on opposite sides of an aircraft and configured to generate drag while being able to be controlled to generate drag without additional resultant moments about the center of gravity of the aircraft. Such additional resultant moments can include, for example, a resultant yawing moment that would otherwise be generated by the deflection of the control surfaces on only one side of the aircraft. Generally, examples of the present disclosure enable control of aircraft, at any point in the flight phase, in addition to increasing descent rate (e.g., increasing drag during a landing operation). This can include, for example, reducing accelerations. By way of non-limiting example, in an upset maneuver (e.g., increase in dive speed beyond maximum operating speed), the teachings of the present disclosure can help reduce acceleration to a keep dive speed lower for a given maximum operating speed. Additionally, during an unintended acceleration event, such as a gust of wind, aspects of the present disclosure can minimize a maximum aircraft speed change during the unintended acceleration event.

The example control system 900 of FIG. 9 includes a rudder symmetric speedbrake logic module 910 that has an input for receiving a number of aircraft performance and operational parameters, such as weight on wheels 911, AUTO speedbrake toggle 912, ALL rudders operational check 913, and an ALL engines operational check 914. The logic module 910 uses the results of this input 915 to switch a command bias module (e.g., +30 degrees) into a rate limiter (e.g., 20 degrees/second) to deliver a speedbrake command to the master flight control system logic. The logic can have direct control over the input to the servoloop actuators 961, 963 disposed, for example, in an empennage that physically move the control components 971, 973 (e.g., rudders). The master flight logic of the control system 900 can include a number of inputs, such as a rudder pedal input 921 (or whichever pilot input corresponds to the control components 971, 973), an autopilot input 922, and a rudder trim input 923, each of which can be passed through a scaling and filter module 931 and/or a scaling module 933. In the illustrated embodiment, this can occur with the rudder trim input 923 being further passed through a rudder trim limiter 943 (e.g., +/−1.5 degrees). Before the pilot or autopilot commands (e.g., from the respective inputs 921, 922) to the port and starboard servoloop actuators 961, 963, they both can be additively adjusted by the rudder trim command (e.g., from rudder trim input 923) in corresponding port and starboard combiners 948, 949. The combiners 948, 949 can also receive the speedbrake commands from the rudder symmetric speedbrake logic module 910, with a first combiner 948 additively combining the speedbrake command and a second combiner 949 subtracting the speedbrake command to command the control components 971, 973 to move in equal and opposite directions (as indicated by arrows 981, 983). Such movement can be a function of the speedbrake command and can occur while maintaining the pilot and autopilot control over the individual control components 971, 973.

For example, if a pilot commands+5 degrees of deflection of the first control component 971 and +10 degrees of deflection of the second control component 973, and the speedbrake logic module 910 commands+20 degrees of speedbrake deflection, then the resultant movement of the first control component 971 is +25 degrees and the resultant movement of the second control component 973 is −10 degrees. Accordingly, a generalized interpretation of this result can be seen as a total of +15 degrees of rudder deflection that generates a yaw (e.g., same as the +5 and +10 as commanded by the pilot), as well as 35 degrees of drag-inducing deflection, which is close to the commanded 40 degrees (e.g., +20 degrees for each control component 971, 973), and is only less than 40 because of the different first and second rudder inputs by the pilot (e.g., +5 and +10). In situations where the pilot or autopilot commands equal first and second control component 971, 973 movements (e.g., +5 and +5, which represents a more typical command input for aircraft with two rudders being commanded to generate an aircraft yaw), then the speedbrake command of 40 degrees of drag-inducing deflection can be achieved will also meeting the +10 degrees of yaw-inducing deflection.

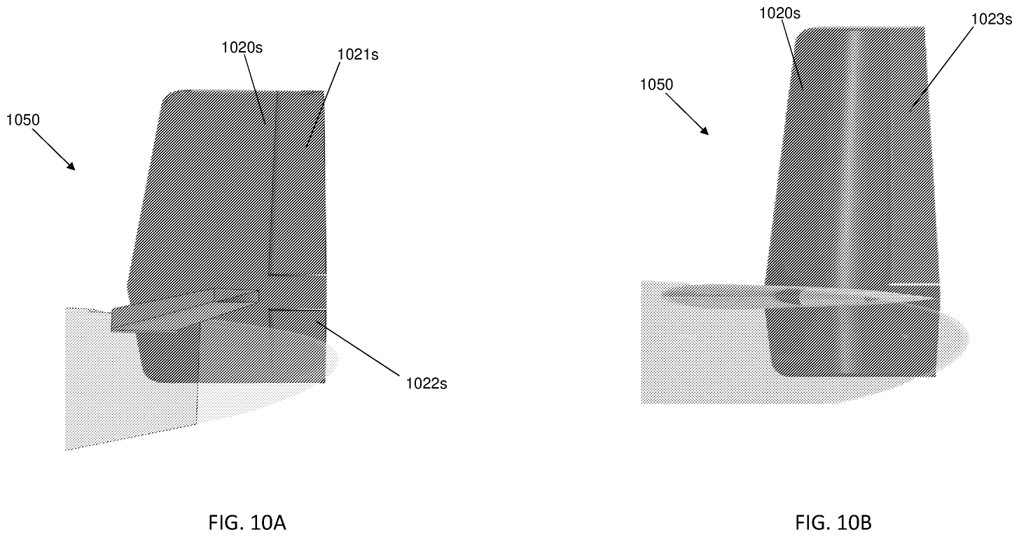

FIGS. 10A and 10B are side views of other examples of empennage control surface arrangement. While the empennage 150 illustrated in FIGS. 8A-8C includes symmetric upper and lower rudders on both sides of the empennage 150, other configurations are possible, such as the asymmetric rudder 1021s, 1022s arrangement as shown on the starboard vertical stabilizer 1020s of the example empennage 1050 of FIG. 10A. In FIG. 10A, the starboard vertical stabilizer 1020s includes a larger upper starboard rudder 1021s and a smaller lower starboard rudder 1022s. In some examples, both starboard and port vertical stabilizers can have a symmetric rudder arrangement, and the location of the vertical stabilizers can be symmetric about the center longitudinal axis of the aircraft. However, other arrangements are possible and one skilled in the art will appreciate that rudder symmetry, including port/starboard symmetry and/or upper/lower symmetry, may not be required to perform any of the methods disclosed herein. Instead, it is sufficient to have both port and starboard rudders that are capable of moving symmetrically and asymmetrically, as well as be positioned to generate trim drag on the aircraft. Moreover, it is understood that in any of the speedbraking or control methods disclosed herein, that additional movements of the aircraft may be induced, such as a pitching movement in response to speedbraking due to a vertical offset of the trim drag vector and the center of gravity of the aircraft. Accordingly, examples of the present method include using additional control surfaces, e.g., elevators 840, to counteract any additional moments or forces applied to the aircraft during a speedbraking operation. In other examples, and as shown in FIG. 10B, only a single rudder 1023s (shown as a starboard rudder) may be present on each vertical stabilizer 1020s. One skilled in the art will appreciate that that any number of rudders or control surfaces can be present and/or utilized on opposing sides of an aircraft to carry out examples of the present disclosure so long as opposing forces are able to be generated on opposite sides of a center of gravity of the aircraft to generate a drag force(s) while controlling and/or not generating additional moments about the center of gravity, such as pitching and/or yawing moments.

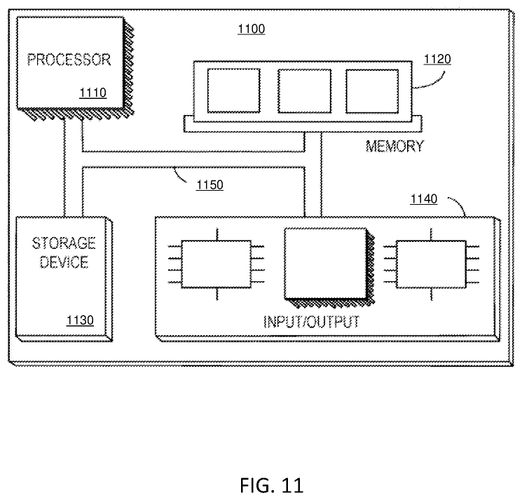

FIG. 11 is a block diagram of one exemplary embodiment of a computer system 1100 upon which the present disclosures can be built, performed, trained, etc. FIG. 11 illustrates an example method to incorporate a symmetric speedbrake command bias into the normal rudder control scheme. For example, a system 1100, which may be a computer or a network of computer or controllers, and can include any number of modules or subsystems that can alone, or in combination, carry out the function of an aircraft flight computer or control surfaces controller and any of the associated modules or routines described therein. The system 1100 can include a processor 1110, a memory 1120, a storage device 1130, and an input/output device 1140. Each of the components 1110, 1120, 1130, and 1140 can be interconnected, for example, using a system bus 1150. The processor 1110 can be capable of processing instructions for execution within the system 1100. The processor 1110 can be a single-threaded processor, a multi-threaded processor, or similar device. The processor 1110 can be capable of processing instructions stored in the memory 1120 or on the storage device 1130. The processor 1110 may execute operations such as conducting one or more aspects a flight control system configured to send comments to aircraft control surfaces, such as the control system 900 of FIG. 9 or one or more parts of the control system 900, or any system configured to control or simulate control of flight control surfaces among other features described in conjunction with the present disclosure.

The memory 1120 can store information within the system 1100. In some implementations, the memory 1120 can be a computer-readable medium. The memory 1120 can, for example, be a volatile memory unit or a non-volatile memory unit. In some implementations, the memory 1120 can store information related to aircraft parameters, flight parameters, cargo parameters and airport runway information, among other information.

The storage device 1130 can be capable of providing mass storage for the system 1100. In some implementations, the storage device 1130 can be a non-transitory computer-readable medium. The storage device 1130 can include, for example, a hard disk device, an optical disk device, a solid-date drive, a flash drive, magnetic tape, and/or some other large capacity storage device. The storage device 1130 may alternatively be a cloud storage device, e.g., a logical storage device including multiple physical storage devices distributed on a network and accessed using a network. In some implementations, the information stored on the memory 1120 can also or instead be stored on the storage device 1130.

The input/output device 1140 can provide input/output operations for the system 1100. In some implementations, the input/output device 1140 can include one or more of network interface devices (e.g., an Ethernet card or an Infiniband interconnect), a serial communication device (e.g., an RS-232 10 port), and/or a wireless interface device (e.g., a short-range wireless communication device, an 802.7 card, a 3G wireless modem, a 4G wireless modem, a 5G wireless modem). In some implementations, the input/output device 1140 can include driver devices configured to receive input data and send output data to other input/output devices, e.g., a keyboard, a printer, and/or display devices. In some implementations, mobile computing devices, mobile communication devices, and other devices can be used.

In some implementations, the system 1100 can be a microcontroller. A microcontroller is a device that contains multiple elements of a computer system in a single electronics package. For example, the single electronics package could contain the processor 1110, the memory 1120, the storage device 1130, and/or input/output devices 1140.

Although an example processing system has been described above, implementations of the subject matter and the functional operations described above can be implemented in other types of digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible program carrier, for example a computer-readable medium, for execution by, or to control the operation of, a processing system. The computer readable medium can be a machine-readable storage device, a machine-readable storage substrate, a memory device, a composition of matter effecting a machine-readable propagated signal, or a combination of one or more of them.

Various embodiments of the present disclosure may be implemented at least in part in any conventional computer programming language. For example, some embodiments may be implemented in a procedural programming language (e.g., “C” or ForTran95), or in an object-oriented programming language (e.g., “C++”). Other embodiments may be implemented as a pre-configured, stand-along hardware element and/or as preprogrammed hardware elements (e.g., application specific integrated circuits, FPGAs, and digital signal processors), or other related components.

The term “computer system” may encompass all apparatus, devices, and machines for processing data, including, by way of non-limiting examples, a programmable processor, a computer, or multiple processors or computers. A processing system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, executable logic, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Such implementation may include a series of computer instructions fixed either on a tangible, non-transitory medium, such as a computer readable medium. The series of computer instructions can embody all or part of the functionality previously described herein with respect to the system. Computer readable media suitable for storing computer program instructions and data include all forms of non-volatile or volatile memory, media and memory devices, including by way of example semiconductor memory devices, e.g., EPROM, EEPROM, and flash memory devices; magnetic disks, e.g., internal hard disks or removable disks or magnetic tapes; magneto optical disks; and CD-ROM and DVD-ROM disks. The processor and the memory can be supplemented by, or incorporated in, special purpose logic circuitry. The components of the system can be interconnected by any form or medium of digital data communication, e.g., a communication network. Examples of communication networks include a local area network (“LAN”) and a wide area network (“WAN”), e.g., the Internet.

Those skilled in the art should appreciate that such computer instructions can be written in a number of programming languages for use with many computer architectures or operating systems. Furthermore, such instructions may be stored in any memory device, such as semiconductor, magnetic, optical, or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud computing model. Of course, some embodiments of the present disclosure may be implemented as a combination of both software (e.g., a computer program product) and hardware. Still other embodiments of the present disclosure are implemented as entirely hardware, or entirely software.

One skilled in the art will appreciate further features and advantages of the disclosures based on the provided for descriptions and embodiments. Accordingly, the inventions are not to be limited by what has been particularly shown and described. For example, although the present disclosure provides for transporting large cargo, such as wind turbines, the present disclosures can also be applied to other types of large cargos or to smaller cargo. All publications and references cited herein are expressly incorporated herein by reference in their entirety.

### Examples of the Above-Described Embodiments can Include the Following

1. A method of operating an aircraft in flight, comprising:
   deflecting a first empennage control surface to cause a first drag force and at least one of a first yawing moment or a first pitching moment on the aircraft; and
   deflecting a second empennage control surface to cause a second drag force and at least one of a second yawing moment or a second pitching moment on the aircraft,
   wherein at least one of:
      the first and second yawing moments destructively combine to generate a resultant yawing moment about a center of gravity of the aircraft that is less than one or both of the first and second yawing moments, or
      the first and second pitching moments destructively combine to generate a resulting pitching moment about a center of gravity of the aircraft that is less than one or both of the first and second pitching moments, and
   wherein the first and second drag forces constructively combine to generate a resultant drag force on the aircraft.
2. The method of claim 1, wherein at least one of the first and second yawing moments cancel to generate no net yaw moment on the aircraft or the first and second pitching moments cancel to generate no net pitching moment on the aircraft.
3. The method of claim 2,
   wherein the first empennage control surface is deflected a first degree,
   wherein the second empennage control surface is deflected a second degree, and
   wherein the first and second degrees are equal and opposite.
4. The method of claim 2 or 3, wherein the deflecting of the first and second empennage control surfaces takes place during a landing operation of the aircraft such that the resultant drag force at least partially reduces a groundspeed of the aircraft to a touchdown speed.
5. The method of claim 4, wherein the deflecting of the first and second empennage control surfaces takes place during the landing operation of the aircraft and after a touchdown operation such that the resultant drag force at least partially reduces a groundspeed of the aircraft to at least one of a taxi speed or a stop.
6. The method of claim 2, wherein the deflecting of the first and second empennage control surfaces takes place during at least one of: a rejected takeoff operation, an increased descent rate operation, or an unintended acceleration of the aircraft such that the resultant drag force at least partially reduces a groundspeed or airspeed of the aircraft.
7. The method of any of claims 1 to 6, wherein the first and second empennage control surfaces are disposed approximately symmetrically about a longitudinal axis of the aircraft.
8. The method of any of claims 1 to 7, wherein the first empennage control surface comprises at least one right rudder, and wherein the second empennage control surface comprises at least one left rudder.
9. The method of claim 8,
   wherein the at least one right rudder comprises an upper right rudder and a lower right rudder, and
   wherein the at least one left rudder comprises an upper left rudder and a lower left rudder.
10. The method of claim 9, wherein the upper and lower right rudders and the upper and lower left rudders form an H-configuration for an empennage of the aircraft.
11. The method of any of claims 1 to 10,
   wherein the first empennage control surface comprises a first elevator, and
   wherein the second empennage control surface comprises a second elevator.
12. The method of any of claims 1 to 11, further comprising:
   reducing an airspeed of the aircraft while conducting at least one of a yawing movement or a pitching movement by simultaneously controlling the respective resultant yawing moment or pitching movement and resultant drag force,
   wherein the simultaneously controlling includes adjusting both of the first and second empennage control surfaces.
13. The method of claim 12, wherein the reducing an airspeed of the aircraft while conducting at least one of a yawing movement or a pitching movement takes places during a landing operation of the aircraft.
14. The method of any of claims 1 to 13, further comprising:
   deflecting a first aileron to cause a first additional drag force and a first rolling moment on the aircraft; and
   deflecting a second aileron to cause a second additional drag force and a second rolling moment on the aircraft,
   wherein the first and second rolling moments destructively combine to generate a resultant rolling moment about a center of gravity of the aircraft that is less than one or both of the first and second rolling moments, and
   wherein the first and second additional drag forces constructively combine to generate a resultant drag force on the aircraft.
15. The method of claim 14, wherein the first and second rolling moments cancel to generate no net rolling moment on the aircraft.
16. The method of claim 15,
   wherein the first aileron is deflected a first degree,
   wherein the second aileron is deflected a second degree, and
   wherein the first and second degrees are equal and opposite.
17. An aircraft control system, comprising:
   a flight control processor configured to simultaneously command
      (1) deflection of a first empennage control surface to cause a first drag force and at least one of a first yawing moment or a first pitching moment on an aircraft; and
      (2) deflection of a second empennage control surface to cause a second drag force and at least one of a second yawing moment or a second pitching moment on the aircraft,
   wherein at least one of:
      the first and second yawing moments destructively combine to generate a resultant yawing moment about a center of gravity of the aircraft that is less than one or both of the first and second yawing moments, or
      the first and second pitching moments destructively combine to generate a resulting pitching moment about a center of gravity of the aircraft that is less than one or both of the first and second pitching moments, and
      wherein the first and second drag forces constructively combine to generate a resultant drag force on the aircraft.
18. The aircraft control system of claim 17, wherein the flight control processor is further configured to command the deflections of the first and second empennage control surfaces such that the at least one of the first and second yawing moments cancel to generate no net yawing moment on the aircraft or the first and second pitching moments cancel to generate no net pitching moment on the aircraft.
19. The aircraft control system of claim 17 or 18, wherein the flight control processor is further configured to command equal and opposite deflections of the first and second empennage control surfaces.
20. The aircraft control system of any of claims 16 to 19, wherein the flight control processor is further configured to assist the control of the aircraft during a landing operation by commanding the deflection such that the resultant drag force at least partially reduces a groundspeed of the aircraft to a touchdown speed.
21. The aircraft control system of any of claims 17 to 20,
   wherein the first empennage control surface comprises at least one right rudder, and
   wherein the second empennage control surface comprises at least one left rudder.
22. The aircraft control system of claim 21,
   wherein the at least one right rudder comprises an upper right rudder and a lower right rudder, and
   wherein the at least one left rudder comprises an upper left rudder and a lower left rudder.
23. The aircraft control system of claim 22, wherein the upper and lower right rudders and the upper and lower left rudders form an H-configuration for an empennage of the aircraft.
24. The aircraft control system of any of claims 17 to 23, wherein the flight control processor is further configured to reduce the airspeed of the aircraft while conducting at least one of a yawing movement or a pitching movement by simultaneously controlling the respective resultant yawing moment or pitching moment and resultant drag force by adjusting the commanded deflections of the first and second empennage control surfaces.
25. The aircraft control system of any of claims 17 to 24, wherein the flight control processor is further configured to simultaneously command
   (1) deflection of a first aileron to cause a first additional drag force and a first rolling moment on the aircraft; and
   (2) deflection of a second aileron to cause a second additional drag force and a second rolling moment on the aircraft,
   wherein the first and second rolling moments destructively combine to generate a resultant rolling moment about a center of gravity of the aircraft that is less than one or both of the first and second rolling moments, and
   wherein the first and second additional drag forces constructively combine to generate a resultant drag force on the aircraft.
26. The aircraft control system of claim 25, wherein the flight control processor is further configured to command the deflections of the first and second ailerons such that the first and second rolling moments cancel to generate no net rolling moment on the aircraft.
27. The aircraft control system of claim 26, wherein the flight control processor is further configured to command equal and opposite deflections of the first and second ailerons.

What is claimed is:

1. A method of operating an aircraft in flight, comprising:
deflecting a first empennage control surface to cause a first drag force and at least one of a first yawing moment or a first pitching moment on the aircraft; and
deflecting a second empennage control surface to cause a second drag force and at least one of a second yawing moment or a second pitching moment on the aircraft,
wherein at least one of:
the first and second yawing moments destructively combine to generate a resultant yawing moment about a center of gravity of the aircraft that is less than one or both of the first and second yawing moments, or
the first and second pitching moments destructively combine to generate a resulting pitching moment about a center of gravity of the aircraft that is less than one or both of the first and second pitching moments, and
wherein the first and second drag forces constructively combine to generate a resultant drag force on the aircraft.

2. The method of claim 1, wherein at least one of the first and second yawing moments cancel to generate no net yaw moment on the aircraft or the first and second pitching moments cancel to generate no net pitching moment on the aircraft.

3. The method of claim 2,
wherein the first empennage control surface is deflected a first degree,
wherein the second empennage control surface is deflected a second degree, and
wherein the first and second degrees are equal and opposite.

4. The method of claim 2, wherein the deflecting of the first and second empennage control surfaces takes place during a landing operation of the aircraft such that the resultant drag force at least partially reduces a groundspeed of the aircraft to a touchdown speed.

5. The method of claim 4, wherein the deflecting of the first and second empennage control surfaces takes place during the landing operation of the aircraft and after a touchdown operation such that the resultant drag force at least partially reduces a groundspeed of the aircraft to at least one of a taxi speed or a stop.

6. The method of claim 2, wherein the deflecting of the first and second empennage control surfaces takes place during at least one of: a rejected takeoff operation, an increased descent rate operation, or an unintended acceleration of the aircraft such that the resultant drag force at least partially reduces a groundspeed or airspeed of the aircraft.

7. The method of any of claim 1, wherein the first and second empennage control surfaces are disposed approximately symmetrically about a longitudinal axis of the aircraft.

8. The method of claim 1,
wherein the first empennage control surface comprises at least one right rudder, and
wherein the second empennage control surface comprises at least one left rudder.

9. The method of claim 8,
wherein the at least one right rudder comprises an upper right rudder and a lower right rudder, and
wherein the at least one left rudder comprises an upper left rudder and a lower left rudder.

10. The method of claim 9, wherein the upper and lower right rudders and the upper and lower left rudders form an H-configuration for an empennage of the aircraft.

11. The method of claim 1,
wherein the first empennage control surface comprises a first elevator, and
wherein the second empennage control surface comprises a second elevator.

12. The method of claim 1, further comprising:
reducing an airspeed of the aircraft while conducting at least one of a yawing movement or a pitching movement by simultaneously controlling the respective resultant yawing moment or pitching movement and resultant drag force,
wherein the simultaneously controlling includes adjusting both of the first and second empennage control surfaces.

13. The method of claim 12, wherein the reducing an airspeed of the aircraft while conducting at least one of a yawing movement or a pitching movement takes places during a landing operation of the aircraft.

14. The method of claim 1, further comprising:
deflecting a first aileron to cause a first additional drag force and a first rolling moment on the aircraft; and
deflecting a second aileron to cause a second additional drag force and a second rolling moment on the aircraft,
wherein the first and second rolling moments destructively combine to generate a resultant rolling moment about a center of gravity of the aircraft that is less than one or both of the first and second rolling moments, and
wherein the first and second additional drag forces constructively combine to generate a resultant drag force on the aircraft.

15. The method of claim 14, wherein the first and second rolling moments cancel to generate no net rolling moment on the aircraft.

16. The method of claim 15,
wherein the first aileron is deflected a first degree,
wherein the second aileron is deflected a second degree, and
wherein the first and second degrees are equal and opposite.

17. An aircraft control system, comprising:
a flight control processor configured to simultaneously command
(1) deflection of a first empennage control surface to cause a first drag force and at least one of a first yawing moment or a first pitching moment on an aircraft; and
(2) deflection of a second empennage control surface to cause a second drag force and at least one of a second yawing moment or a second pitching moment on the aircraft,
wherein at least one of:
the first and second yawing moments destructively combine to generate a resultant yawing moment about a center of gravity of the aircraft that is less than one or both of the first and second yawing moments, or
the first and second pitching moments destructively combine to generate a resulting pitching moment about a center of gravity of the aircraft that is less than one or both of the first and second pitching moments, and
wherein the first and second drag forces constructively combine to generate a resultant drag force on the aircraft.

18. The aircraft control system of claim 17, wherein the flight control processor is further configured to command the deflections of the first and second empennage control surfaces such that the at least one of the first and second yawing moments cancel to generate no net yawing moment on the aircraft or the first and second pitching moments cancel to generate no net pitching moment on the aircraft.

19. The aircraft control system of claim 17, wherein the flight control processor is further configured to command equal and opposite deflections of the first and second empennage control surfaces.

20. The aircraft control system of claim 17, wherein the flight control processor is further configured to assist the control of the aircraft during a landing operation by commanding the deflection such that the resultant drag force at least partially reduces a groundspeed of the aircraft to a touchdown speed.

21. The aircraft control system of claim 17,
wherein the first empennage control surface comprises at least one right rudder, and
wherein the second empennage control surface comprises at least one left rudder.

22. The aircraft control system of claim 21,
wherein the at least one right rudder comprises an upper right rudder and a lower right rudder, and
wherein the at least one left rudder comprises an upper left rudder and a lower left rudder.

23. The aircraft control system of claim 22, wherein the upper and lower right rudders and the upper and lower left rudders form an H-configuration for an empennage of the aircraft.

24. The aircraft control system of claim 17, wherein the flight control processor is further configured to reduce the airspeed of the aircraft while conducting at least one of a yawing movement or a pitching movement by simultaneously controlling the respective resultant yawing moment or pitching moment and resultant drag force by adjusting the commanded deflections of the first and second empennage control surfaces.

25. The aircraft control system of claim 17, wherein the flight control processor is further configured to simultaneously command:
(1) deflection of a first aileron to cause a first additional drag force and a first rolling moment on the aircraft; and
(2) deflection of a second aileron to cause a second additional drag force and a second rolling moment on the aircraft,
wherein the first and second rolling moments destructively combine to generate a resultant rolling moment about a center of gravity of the aircraft that is less than one or both of the first and second rolling moments, and
wherein the first and second additional drag forces constructively combine to generate a resultant drag force on the aircraft.

26. The aircraft control system of claim 25, wherein the flight control processor is further configured to command the deflections of the first and second ailerons such that the first and second rolling moments cancel to generate no net rolling moment on the aircraft.

27. The aircraft control system of claim 26, wherein the flight control processor is further configured to command equal and opposite deflections of the first and second ailerons.
